(19) United States
(12) Patent Application Publication
(10) Pub. No.: US 2022/0234425 A1
(43) Pub. Date: Jul. 28, 2022

(54) COMPONENT FOR VEHICLE INTERIOR

(71) Applicant: Shanghai Yanfeng Jinqiao Automotive Trim Systems Co. Ltd., Novi, MI (US)

(72) Inventor: Liluo Wang, Shanghai (CN)

(21) Appl. No.: 17/716,411

(22) Filed: Apr. 8, 2022

Related U.S. Application Data
(63) Continuation-in-part of application No. PCT/CN2020/120209, filed on Oct. 10, 2020.

(30) Foreign Application Priority Data
Oct. 10, 2019 (CN) 201910959788.1
Oct. 10, 2019 (CN) 201910960428.3

(51) Int. Cl. B60H 1/34; B60H 1/00

(52) U.S. Cl. CPC B60H 1/3414; B60K 37/02; B60H 1/0065

(57) ABSTRACT

An air outlet assembly for airflow in a vehicle interior is disclosed. The air outlet assembly may comprise a housing, a vertical guide assembly, a horizontal guide assembly and an operator control to actuate a vertical guide mechanism and a horizontal guide mechanism. The operator control may comprise a knob and a shaft providing an axis. Rotation of the operator control may comprise rotation of the shaft about the axis; pivoting of the operator control may comprise linear movement of the knob between a raised position and a lowered position. The operator control may translate to actuate an air door assembly to permit airflow and to obstruct airflow. Translation of the operator control may comprise linear movement of the shaft in a direction along the axis. The operator control may actuate the vertical guide mechanism independently of the horizontal guide mechanism.

### CROSS-REFERENCE TO RELATED APPLICATIONS

The present application is a continuation-in-part of PCT/International Patent Application No. PCT/CN2020/120209 filed Oct. 10, 2020, which claims the benefit of Chinese Patent Application No. CN201910959788.1 filed Oct. 10, 2019 (now Chinese Patent No. 110576722B) and Chinese Patent Application No. 201910960428.3 filed Oct. 10, 2019 (now Chinese Patent No. 110576723B).

The present application claims priority to and incorporates by reference in full the following patent applications: (a) Chinese Patent Application No. CN201910959788.1 filed Oct. 10, 2019 (now Chinese Patent No. 110576722B); (b) Chinese Patent Application No. 201910960428.3 filed Oct. 10, 2019 (now Chinese Patent No. 110576723B); (c) PCT/International Patent Application No. PCT/CN2020/120209 filed Oct. 10, 2020.

### FIELD

The present invention relates to a component for a vehicle interior.

The present invention also relates to a component for a vehicle interior comprising an air outlet assembly.

The present invention further relates to a component for a vehicle interior comprising an air outlet assembly comprising an air outlet structure.

### BACKGROUND

It is known to provide an air outlet in a vehicle interior with a control to direct airflow.

It would be advantageous to provide an improved component for a vehicle interior comprising an air outlet assembly for airflow.

It would also be advantageous to provide an improved component for a vehicle interior comprising an air outlet assembly for airflow providing an operator control configured to actuate at least one air guide assembly.

It would also be advantageous to provide an improved component for a vehicle interior comprising an air outlet assembly providing an operator control configured to actuate at least one air guide assembly and/or an air door assembly with rotating action and/or translating action and/or pivoting action.

### SUMMARY

The present invention relates to an air outlet assembly for airflow in a vehicle interior comprising a housing providing an outlet, a vertical guide assembly configured to guide airflow through the outlet, a horizontal guide assembly configured to guide airflow through the outlet and an operator control configured to actuate (1) a vertical guide mechanism for the vertical guide assembly and (2) a horizontal guide mechanism for the horizontal guide assembly. The operator control may be configured to provide a rotating action and a pivoting action. The operator control may be configured to actuate an air door assembly. The operator control may comprise a knob and a shaft providing an axis. The rotating action of the operator control may comprise rotation of the shaft about the axis; the pivoting action of the operator control may comprise linear movement of the knob. The pivoting action of the operator control may comprise linear movement of the knob between a raised position and a lowered position. The air door assembly may be configured to be actuated by an air door mechanism. The operator control may be configured to provide a translating action to actuate the air door assembly between an open position to permit airflow and a closed position to obstruct airflow. Translating action of the operator control may comprise linear movement of the shaft in a direction along the axis between a retracted position and an extended position. The vertical guide assembly may comprise a set of vertical guides; the vertical guide mechanism may be configured to move the set of vertical guides in a horizontal direction. The horizontal guide assembly may comprise a set of horizontal guides; the horizontal guide mechanism may be configured to move the set of horizontal guides in a vertical direction. The horizontal guide assembly may comprise a set of horizontal guides; the horizontal guide mechanism may be configured to pivot the set of horizontal guides in a vertical direction between a raised position and a lowered position. The air door assembly may comprise a set of air doors; the operator control may be configured to move the set of air doors for the air door assembly between the open position and the closed position. The air door assembly may comprise a set of air doors; the operator control may be configured to pivot the set of air doors for the air door assembly between the open position and the closed position. The operator control may be configured to actuate the vertical guide mechanism independently of the horizontal guide mechanism. The operator control may be configured to actuate the air door mechanism independently of the vertical guide mechanism and/or the horizontal guide mechanism. The vertical guide mechanism may comprise a link member configured to operate the vertical guide assembly. The horizontal guide mechanism may comprise a gear arrangement configured to operate the horizontal guide assembly. The gear arrangement may comprise a gear set. The horizontal guide mechanism may comprise a mounting plate and the gear arrangement may comprise a gear set. The knob may comprise a dial and the shaft may comprise a tube. The operator control may be movable relative to the housing. The operator control may comprise a knob on a shaft projecting from an opening in the housing. The opening may comprise a slot in the housing. The air outlet assembly may comprise a base for the housing; the base may comprise an inlet for airflow. The vertical guide assembly may be mounted within the base. The horizontal guide assembly may be mounted within the base. The air door assembly may be mounted within the base. The air door mechanism may comprise a gear arrangement configured to operate the air door assembly. The air door assembly may comprise a set of air doors; the set of air doors may comprise a set of panels. The vertical guide assembly may comprise a set of vertical guides; the set of vertical guides may comprise a set of vanes. The horizontal guide assembly may comprise a set of horizontal guides; the set of horizontal guides may comprise a set of vanes.

The present invention relates to an air outlet assembly for airflow in a vehicle interior comprising a base providing an inlet, a housing providing an outlet, a vertical guide assembly within the base configured to guide airflow through the outlet, a horizontal guide assembly within the base configured to guide airflow through the outlet, and an operator control configured to actuate (1) a vertical guide mechanism for the vertical guide assembly and (2) a horizontal guide mechanism for the horizontal guide assembly. The operator control may be configured to provide a rotating action and a pivoting action. The operator control may be configured to actuate the vertical guide mechanism independently of the horizontal guide mechanism.

The present invention relates to an air outlet structure providing a channel for airflow, comprising a housing, a vertical guide configured to guide the airflow, a horizontal guide configured to guide the airflow; and a dial lever assembly configured to move the vertical guide and the horizontal guide. The dial lever assembly may be configured to move the vertical guide between left and right positions. The dial lever assembly may be configured to move the horizontal guide between upper and lower positions. The dial lever assembly may be configured to (1) move the horizontal guide by rotating relative to the housing about a first axis parallel to an extension direction of the horizontal guide, and (2) move the vertical guide by rotating relative to the housing about a second axis perpendicular to both the extension direction of the horizontal guide and the extension direction of the vertical guide. The air outlet structure may comprise an air door configured to move between a closed position closing the channel and an open position allowing the airflow therethrough. The dial lever assembly may be configured such that the horizontal guide and the vertical guide are configured to remain in a position relative to the housing when the air door moves between the closed position and the open position. The dial lever assembly may be configured to translate in the direction of the second axis relative to the housing to move the air door between the closed position and the open position. The dial lever assembly may comprise a dial lever configured to move the vertical guide by rotating about the second axis relative to the housing and an air door dial lever configured to move the air door by rotating about the second axis relative to the housing. The vertical guide may be configured as one of front and rear rows of blades, the horizontal guide may be configured as the other one of the front and rear rows of blades. The dial lever assembly may comprise an up-down toggle sleeve and a rotary sleeve, the up-down toggle sleeve may be rotatably mounted on the housing about a first direction, and one of the front and rear rows of blades may be connected with the up-down toggle sleeve; and the rotary sleeve may be rotatable about a second direction relative to the up-down toggle sleeve, the second direction may be perpendicular to the first direction, and the other one of the front and rear rows of blades may be connected with the rotary sleeve. The rotary sleeve passes through the up-down toggle sleeve and has a degree of freedom to rotate about the second direction relative to the up-down toggle sleeve. One of the front and rear rows of blades may be connected with the up-down toggle sleeve by a first blade drive gear, one of the front and rear rows of blade assemblies has a first blade drive link with a shaft, and one end of the first blade drive gear may be connected with the shaft; and the up-down toggle sleeve has a first tooth, and the other end of the first blade drive gear may be engaged with the first tooth. The other one of the front and rear rows of blades may be connected with the rotary sleeve by a ball socket structure, and the other one of the front and rear rows of blade assemblies may be provided with a second blade drive link; the second blade drive link has a ball socket, and the rotary sleeve has a ball head; alternatively, the second blade drive link has a ball head, and the rotary sleeve has a ball socket; and the ball head may be received in the ball socket. The air outlet structure may comprise an air door controlled by retracting and unretracting the dial lever assembly. The dial lever assembly may comprise a dial lever connected with the air door by passing through the rotary sleeve. The dial lever has a degree of freedom to move in the second direction relative to the rotary sleeve. The wall surface of the rotary sleeve may be provided with an opening groove extending forward and backward, and the dial lever has a pin which may be movable in the opening groove. The dial lever assembly may comprise an up-down toggle sleeve rotatably mounted on the housing about a first direction, and one of the front and rear rows of blades may be connected with the up-down toggle sleeve; the dial lever may be rotatable about a second direction relative to the up-down toggle sleeve, the second direction may be perpendicular to the first direction, and the other one of the front and rear rows of blades may be connected to the dial lever. The dial lever passes through the up-down toggle sleeve and has a degree of freedom to rotate relative to the up-down toggle sleeve. One of the front and rear rows of blades has a first blade drive link and may be connected with the up-down toggle sleeves by a first blade drive gear, and the first blade drive link has a shaft with which one end of the first blade drive gear may be connected; and the up-down toggle sleeve has a first tooth, and the other end of the first blade drive gear may be engaged with the first tooth. The other one of the front and rear rows of blades has a second blade drive link and may be connected with the dial lever by a ball socket structure; the second blade drive link has a ball socket, and the dial lever has a ball head; alternatively, the second blade drive link has a ball head, and the dial lever has a ball socket; and the ball head may be received in the ball socket. The air outlet structure may comprise an air door, the dial lever assembly may comprise an air door dial lever inserted into the dial lever, and the air door may be controlled by rotating the air door dial lever. The air door dial lever has a degree of freedom to rotate relative to the dial lever. The air door dial lever may be connected with the air door by a worm/gear. One of the air door dial lever and the worm/gear may be provided with a ball socket, the other one may be provided with a ball head, and a convex point on the ball head may be matched with a groove on the ball socket, so that the air door dial lever drives the rotation of the worm/gear.

### FIGURES

FIG. 1A is a schematic perspective view of a vehicle according to an exemplary embodiment.

FIG. 1B is a schematic partial perspective view of a vehicle interior according to an exemplary embodiment.

FIG. 1C is a schematic perspective view of a component for a vehicle interior according to an exemplary embodiment.

FIG. 1D is a schematic perspective view of a component for a vehicle interior according to an exemplary embodiment.

FIG. 2A is a schematic perspective view of a component for a vehicle interior according to an exemplary embodiment.

FIG. 2B is a schematic exploded perspective view of a component for a vehicle interior according to an exemplary embodiment.

FIGS. 3A through 3E are schematic front views of a component for a vehicle interior according to an exemplary embodiment.

FIG. 4A is a schematic partial exploded perspective view of a component for a vehicle interior according to an exemplary embodiment.

FIG. 4B is a schematic partial perspective view of a component for a vehicle interior according to an exemplary embodiment.

FIG. 5A is a schematic partial exploded perspective view of a component for a vehicle interior according to an exemplary embodiment.

FIG. 5B is a schematic partial perspective view of a component for a vehicle interior according to an exemplary embodiment.

FIG. 6A is a schematic partial exploded perspective view of a component for a vehicle interior according to an exemplary embodiment.

FIG. 6B is a schematic partial perspective view of a component for a vehicle interior according to an exemplary embodiment.

FIG. 7A is a schematic partial exploded perspective view of a component for a vehicle interior according to an exemplary embodiment.

FIG. 7B is a schematic partial perspective view of a component for a vehicle interior according to an exemplary embodiment.

FIG. 8 is a schematic perspective view of a subassembly of a component for a vehicle interior according to an exemplary embodiment.

FIG. 9 is a schematic perspective view of a subassembly of a component for a vehicle interior according to an exemplary embodiment.

FIG. 10 is a schematic partial cutaway front view of a component for a vehicle interior according to an exemplary embodiment.

FIGS. 11A through 11F are schematic perspective views of a component for a vehicle interior according to an exemplary embodiment.

FIGS. 12A through 12C are schematic side views of a component for a vehicle interior according to an exemplary embodiment.

FIGS. 13A through 13C are schematic top views of a component for a vehicle interior according to an exemplary embodiment.

FIGS. 14A through 14C are schematic side views of a component for a vehicle interior according to an exemplary embodiment.

FIGS. 15A through 15B are schematic side views of a component for a vehicle interior according to an exemplary embodiment.

FIG. 16 is a schematic section view of a component for a vehicle interior according to an exemplary embodiment.

FIG. 17A is a schematic perspective view of a component for a vehicle interior according to an exemplary embodiment.

FIG. 17B is a schematic exploded perspective view of a component for a vehicle interior according to an exemplary embodiment.

FIGS. 18A through 18E are schematic front views of a component for a vehicle interior according to an exemplary embodiment.

FIG. 19A is a schematic partial exploded perspective view of a component for a vehicle interior according to an exemplary embodiment.

FIG. 19B is a schematic partial perspective view of a component for a vehicle interior according to an exemplary embodiment.

FIG. 20A is a schematic partial exploded perspective view of a component for a vehicle interior according to an exemplary embodiment.

FIG. 20B is a schematic partial perspective view of a component for a vehicle interior according to an exemplary embodiment.

FIG. 21A is a schematic partial exploded perspective view of a component for a vehicle interior according to an exemplary embodiment.

FIG. 21B is a schematic partial perspective view of a component for a vehicle interior according to an exemplary embodiment.

FIG. 22A is a schematic partial exploded perspective view of a component for a vehicle interior according to an exemplary embodiment.

FIG. 22B is a schematic partial perspective view of a component for a vehicle interior according to an exemplary embodiment.

FIG. 23 is a schematic perspective view of a subassembly of a component for a vehicle interior according to an exemplary embodiment.

FIG. 24 is a schematic perspective view of a subassembly of a component for a vehicle interior according to an exemplary embodiment.

FIG. 25 is a schematic partial cutaway front view of a component for a vehicle interior according to an exemplary embodiment.

FIGS. 26A through 26F are schematic perspective views of a component for a vehicle interior according to an exemplary embodiment.

FIGS. 27A through 27C are schematic side views of a component for a vehicle interior according to an exemplary embodiment.

FIGS. 28A through 28C are schematic top views of a component for a vehicle interior according to an exemplary embodiment.

FIGS. 29A through 29C are schematic side views of a component for a vehicle interior according to an exemplary embodiment.

FIG. 30 is a schematic section view of a component for a vehicle interior according to an exemplary embodiment.

### DESCRIPTION

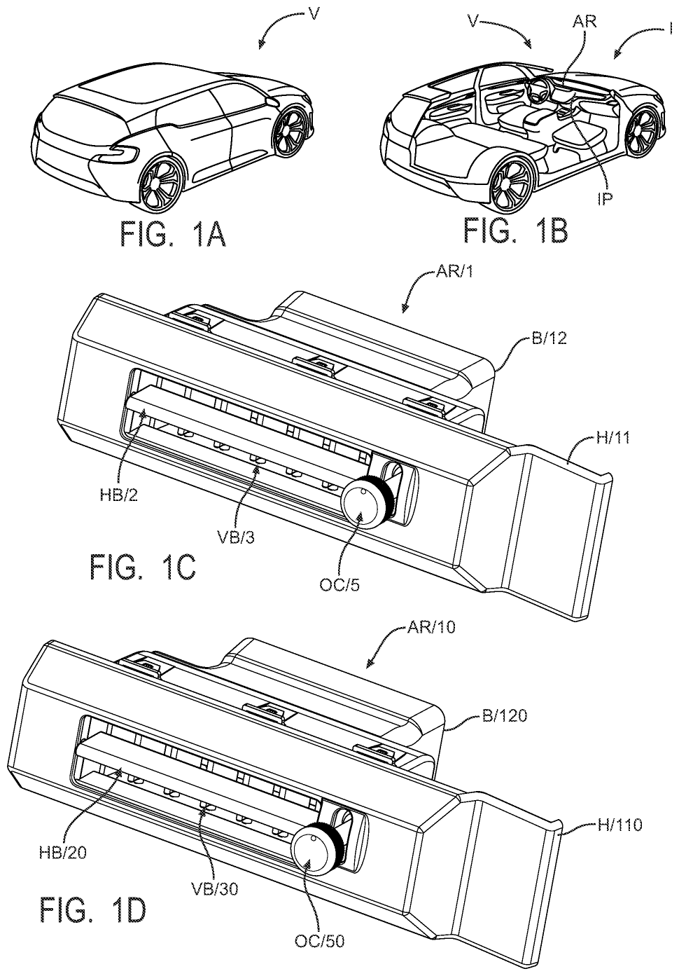

Referring to FIGS. 1A-1B and 1C-1D, a vehicle V is shown with an interior I providing an instrument panel IP comprising a component shown as air outlet assembly AR configured to provide airflow (i.e. from the vehicle heating/cooling and ventilation system) into interior I of vehicle V.

As shown schematically according to an exemplary embodiment in FIGS. 1C-1D, 2A-2B and 17A-17B, an air outlet assembly AR for airflow in a vehicle interior may comprise a housing H providing an outlet, a vertical guide assembly VB configured to guide airflow through the outlet, a horizontal guide assembly HB configured to guide airflow through the outlet and an operator control OC. As indicated schematically in FIGS. 1C-1D, 3A-3E, 7B, 11A-11F, 17A-17B, 18A-18E, 22B and 26A-26F, operator control OC may be configured to actuate a vertical guide mechanism VM for the vertical guide assembly and to actuate a horizontal guide mechanism HM for the horizontal guide assembly.

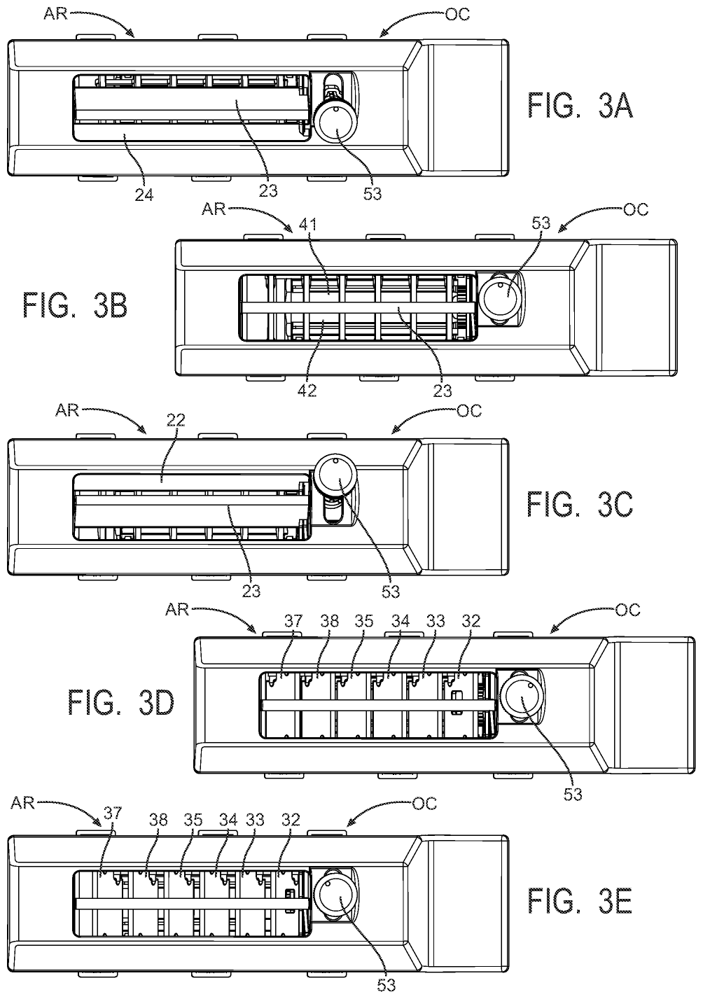

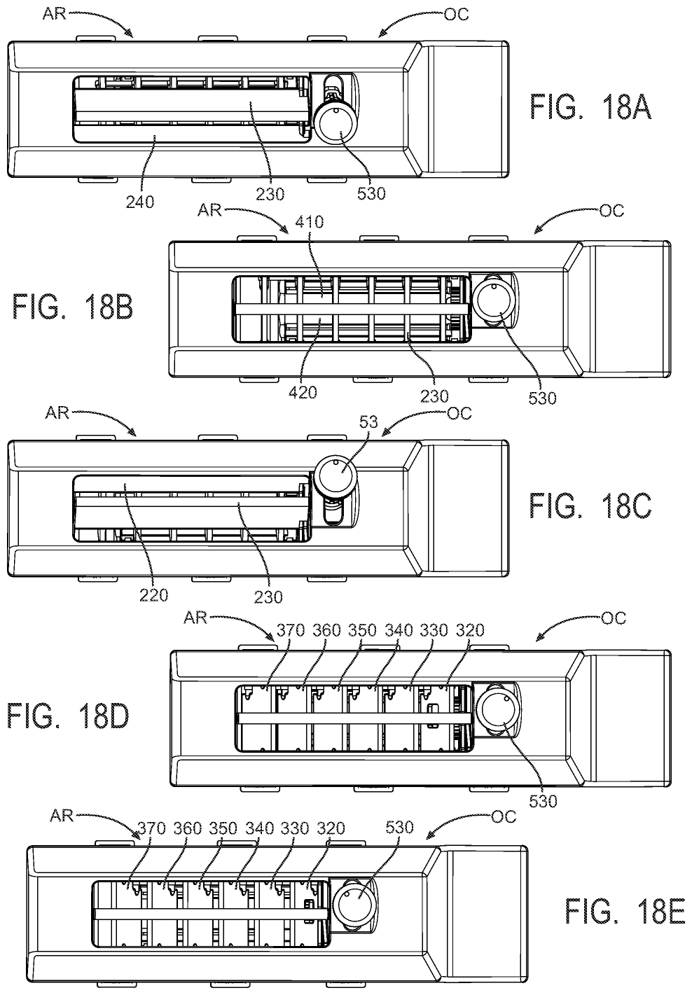

As shown schematically in FIGS. 3A-3E and 18A-18E, operator control OC may be configured to provide a rotating action and a pivoting action. As indicated schematically in FIGURES, 6A-6B, 11E-11F, 12A-12C, 15A-15B, 17A-17B, 21A-21B, 26E-26F and 27A-27C, operator control OC may be configured to actuate an air door assembly AD. As indicated schematically in FIGS. 1C-1D, 3A-3E, 7B, 11A-11F, 17A-17B, 18A-18E, 22B and 26A-26F, operator control OC may comprise a knob and a shaft providing an axis. As shown schematically in FIGS. 3D-3E and 18D-18E, the rotating action of operator control OC may comprise rotation of the shaft about the axis. See also 1C-1D, 2A-2B, 5A-5B, 11A-11B, 13A-13C, 17A-17B, 20A-20B, 26A-26B and 28A-28C. As shown schematically in FIGS. 3A-3C and 18A-18C, the pivoting action of operator control OC may comprise linear movement of the knob; the pivoting action of operator control OC may comprise linear movement of the knob between a raised position and a lowered position. See also FIGS. 1C-1D, 2A-2B, 4A-4B, 11C-11D, 14A-14C, 17A-17B, 19A-19B, 26C-26D and 29A-29C.

As shown schematically in FIGS. 1C-1D, 2A-2B, 6A-6B, 11E-11F, 12A-12C, 15A-15B, 17A-17B, 21A-21B, 26E-26F and 27A-27C, air door assembly AD may be configured to be actuated by an air door mechanism ADM; operator control OC may be configured to provide a translating action to actuate air door assembly AD between an open position to permit airflow and a closed position to obstruct airflow; translating action of operator control OC may comprise linear movement of the shaft in a direction along the axis between a retracted position and an extended position.

As shown schematically according to an exemplary embodiment in FIGS. 1C-1D, 2A-2B, 5A-5B, 11A-11B, 13A-13C, 17A-17B, 20A-20B, 26A-26B and 28A-28C, the vertical guide assembly may comprise a set of vertical guides; vertical guide mechanism VM may be configured to move the set of vertical guides in a horizontal direction. As shown schematically according to an exemplary embodiment in FIGS. 1C-1D, 2A-2B, 4A-4B, 11C-11D, 14A-14C, 17A-17B, 19A-19B, 26C-26D and 29A-29C, the horizontal guide assembly may comprise a set of horizontal guides; horizontal guide mechanism HM may be configured to move the set of horizontal guides in a vertical direction. As shown schematically in FIGS. 1C-1D, 2A-2B, 4A-4B, 11C-11D, 14A-14C, 17A-17B, 19A-19B, 26C-26D and 29A-29C, the horizontal guide assembly may comprise a set of horizontal guides; horizontal guide mechanism HM may be configured to pivot the set of horizontal guides in a vertical direction between a raised position and a lowered position.

As shown schematically according to an exemplary embodiment in FIGS. 1C-1D, 2A-2B, 6A-6B, 11E-11F, 12A-12C, 15A-15B, 17A-17B, 21A-21B, 26E-26F and 27A-27C, air door assembly AD may comprise a set of air doors configured to be actuated by air door mechanism ADM; operator control OC may be configured to move the set of air doors for air door assembly AD between the open position and the closed position. Air door assembly AD may comprise a set of air doors; operator control OC may be configured to pivot the set of air doors for air door assembly AD between the open position and the closed position. See also FIGS. 1C-1D, 2A-2B, 6A-6B, 11E-11F, 12A-12C, 15A-15B, 17A-17B, 21A-21B, 26E-26F and 27A-27C.

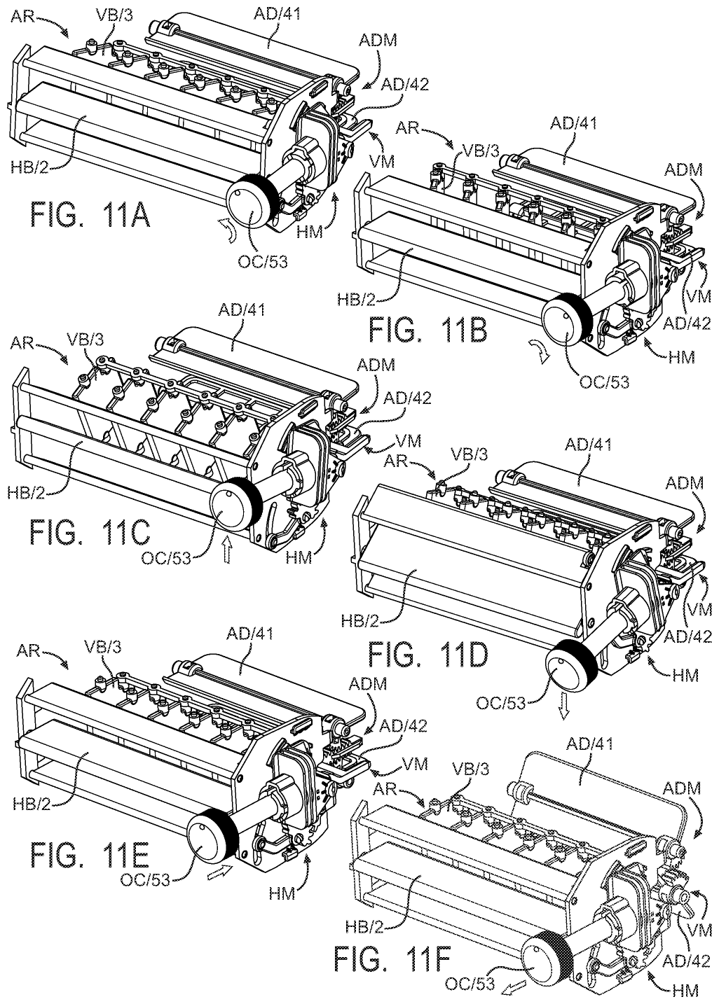

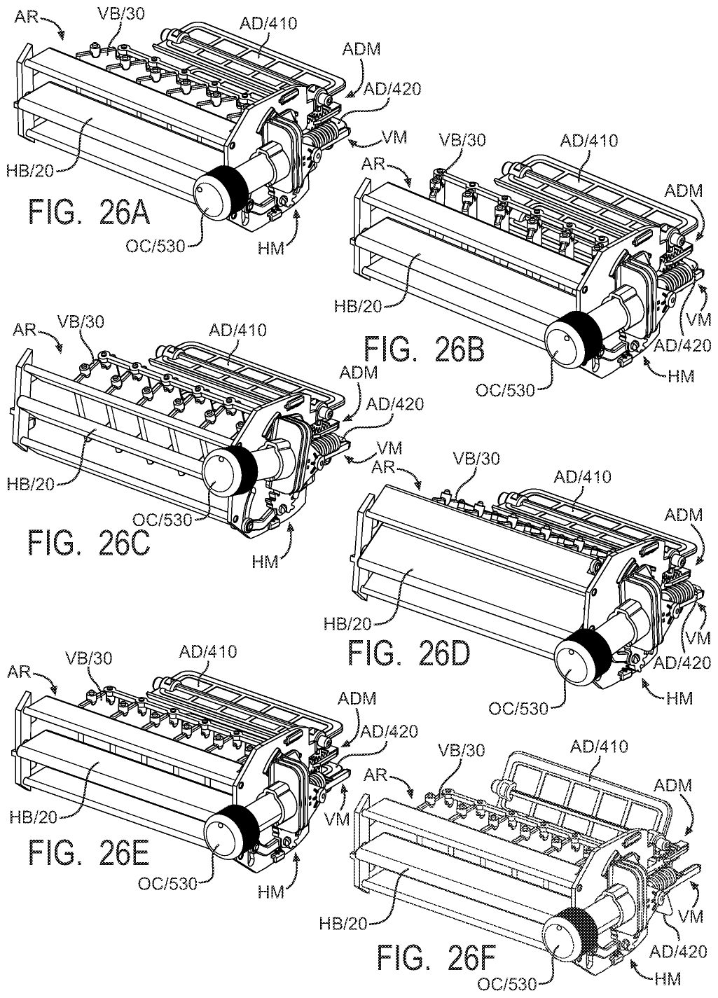

As indicated schematically in FIGS. 11A-11E and 26A-26E, operator control OC may be configured to actuate vertical guide mechanism VM independently of horizontal guide mechanism HM; operator control OC may be configured to actuate air door mechanism ADM independently of vertical guide mechanism VM and/or horizontal guide mechanism HM.

As shown schematically in FIGS. 1C-1D, 2A-2B, 5A-5B, 11A-11B, 13A-13C, 17A-17B, 20A-20B, 26A-26B and 28A-28C, vertical guide mechanism VM may comprise a link member configured to operate the vertical guide assembly. As shown schematically in FIGS. 1C-1D, 2A-2B, 4A-4B, 11C-11D, 14A-14C, 17A-17B, 19A-19B, 26C-26D and 29A-29C, horizontal guide mechanism HM may comprise a gear arrangement configured to operate the horizontal guide assembly; the gear arrangement may comprise a gear set; horizontal guide mechanism HM may comprise a mounting plate and the gear arrangement may comprise a gear set.

As shown schematically according to an exemplary embodiment in FIGS. 1C-1D, 3A-3E, 7B, 11A-11F, 17A-17B, 18A-18E, 22B and 26A-26F, the operator control may comprise a knob and a shaft; the knob may comprise a dial and the shaft may comprise a tube; operator control OC may be movable relative to housing H; operator control OC may comprise a knob on a shaft projecting from an opening in housing H; the opening may comprise a slot in housing H.

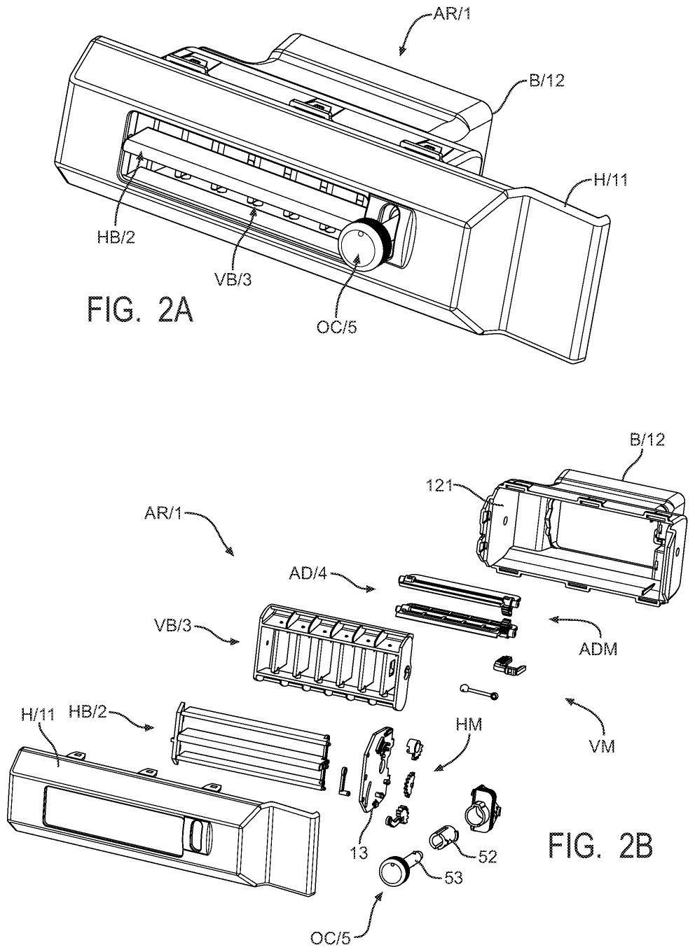

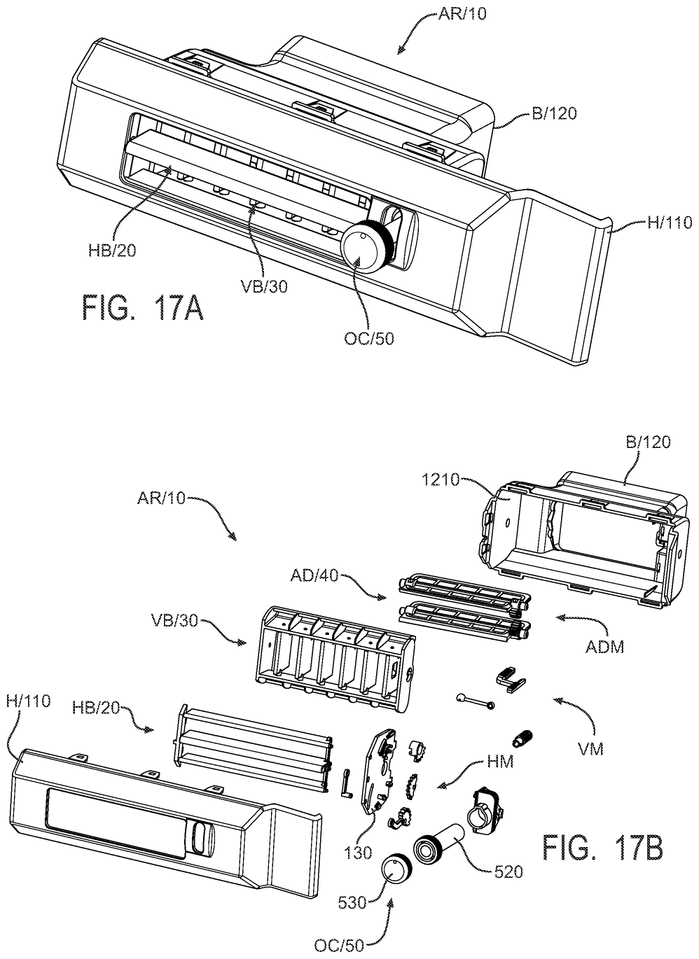

As shown schematically according to an exemplary embodiment in FIGS. 2A-2B and 17A-17B, air outlet assembly AR may comprise a base B for housing H; base B may comprise an inlet for airflow; the vertical guide assembly may be mounted within base B; the horizontal guide assembly may be mounted within base B; air door assembly AD may be mounted within base B.

As shown schematically according to an exemplary embodiment in FIGS. 1C-1D, 2A-2B, 6A-6B, 11E-11F, 12A-12C, 15A-15B, 17A-17B, 21A-21B, 26E-26F and 27A-27C, air door mechanism ADM may comprise a gear arrangement configured to operate air door assembly AD; air door assembly AD may comprise a set of air doors; the set of air doors may comprise a set of panels.

As shown schematically according to an exemplary embodiment in FIGS. 1C-1D, 2A-2B, 5A-5B, 11A-11B, 13A-13C, 17A-17B, 20A-20B, 26A-26B and 28A-28C, vertical guide assembly VB actuated by vertical guide mechanism VM may comprise a set of vertical guides; the set of vertical guides may comprise a set of vanes.

As shown schematically according to an exemplary embodiment in FIGS. 1C-1D, 2A-2B, 4A-4B, 11C-11D, 14A-14C, 17A-17B, 19A-19B, 26C-26D and 29A-29C, horizontal guide assembly HB actuated by horizontal guide mechanism HM may comprise a set of horizontal guides; the set of horizontal guides may comprise a set of vanes.

As shown schematically according to an exemplary embodiment in FIGS. 1C-1D, 2A-2B and 17A-17B, an air outlet assembly AR for airflow in a vehicle interior may comprise a base B providing an inlet, a housing H providing an outlet, a vertical guide assembly within base B configured to guide airflow through the outlet, a horizontal guide assembly within base B configured to guide airflow through the outlet, and an operator control OC configured to actuate a vertical guide mechanism VM for the vertical guide assembly and to actuate a horizontal guide mechanism HM for the horizontal guide assembly.

As shown schematically according to an exemplary embodiment in FIGS. 1C-1D, 3A-3E, 7B, 11A-11F, 17A-17B, 18A-18E, 22B and 26A-26F, operator control OC may be configured to provide a rotating action and a pivoting action; operator control OC may be configured to actuate vertical guide mechanism VM independently of horizontal guide mechanism HM.

### Exemplary Embodiments—A

As shown schematically according to an exemplary embodiments of FIGS. 1A-1D, a vehicle V may provide an interior I with a component shown as an air outlet assembly/structure AR configured to provide for airflow. As shown schematically according to an exemplary embodiment in FIGS. 2A-2B, the air outlet assembly/structure AR may comprise a housing 1, a horizontal blade assembly 2, a perpendicular blade assembly 3, an air door assembly 4, and a dial lever assembly 5; the horizontal blade assembly 2 may be installed at the front end of the housing 1, the perpendicular blade assembly 3 may be installed at the middle of the housing 1; and the air door assembly 4 may be installed at the rear end of the housing 1. A dial lever assembly 5 may be installed on the housing 1 at the sides of the horizontal blade assembly 2 and the perpendicular blade assembly 35 may comprise a dial lever 53; the up-down toggle of the dial lever 53 may drive the rotation of the horizontal blade of the horizontal blade assembly 2 (shown schematically in FIGS. 3A-3C and 11C-11D); and the rotation of the dial lever 53 may drive the rotation of the perpendicular blade of the perpendicular blade assembly 3 (shown schematically in FIGS. 3D-3E and 11A-11B); and the retracting and extending of the dial lever 53 may drive the opening and closing of the air door of the air door assembly 4 (as shown schematically according to an exemplary embodiment in FIGS. 11E-11F).

As shown schematically in FIG. 2B, the housing 1 may comprise a front half-housing 11 and a rear half-housing 12, which are relatively fixed (e.g. by a circumferential snap) to define a receiving cavity for receiving the horizontal blade assembly 2, the perpendicular blade assembly 3, the air door assembly 4 and at least part of the dial lever assembly 5. According to an exemplary embodiment, the housing 1 includes a partition wall 13 fixedly provided between the front half-housing 11 and the rear half-housing 12 and dividing the receiving cavity into a left cavity in which the horizontal blade assembly 2 and the perpendicular blade assembly 3 are received and a right cavity in which at least part of the dial lever assembly 5 is received.

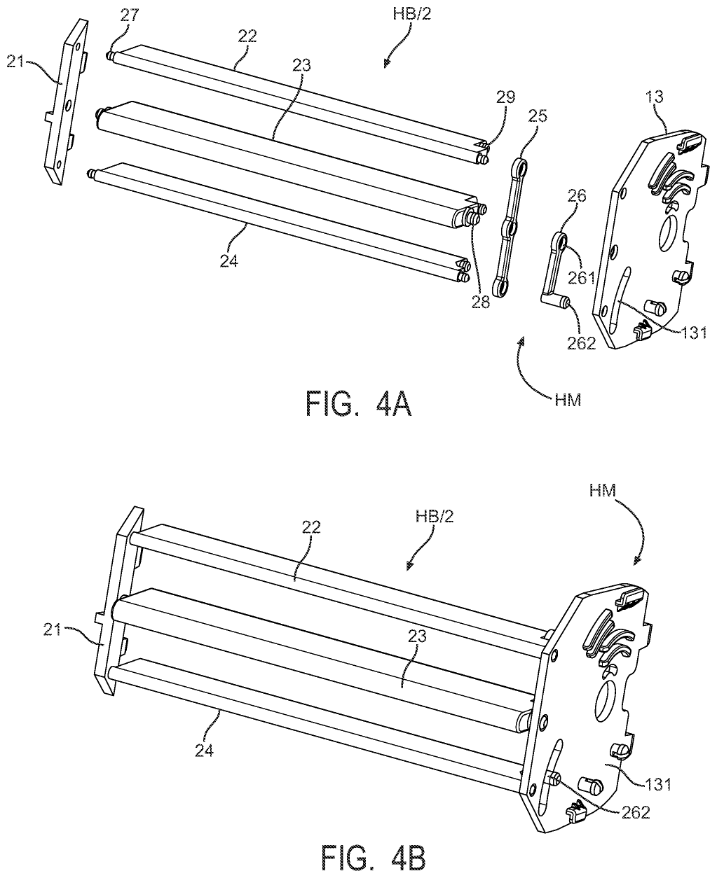

As shown schematically according to an exemplary embodiment in FIGS. 4A-4B, the horizontal blade assembly 2 includes a horizontal blade support 21 and a plurality of horizontal blades 22, 23, 24; each of the horizontal blades 22, 23, 24 includes a left-side shaft 27 on the left side and a right-side shaft 28 and a link shaft 29 on the right side. The left-side shaft 27 and the right-side shaft 28 are coaxial and closer to the outer side of the air outlet opening than the link shaft 29. The left-side shaft 27 of the horizontal blades 22, 23, 24 may be fitted to the horizontal blade support 21 fixed to the housing 1; and the right-side shaft 28 may be fitted to the partition wall 13. As indicated schematically, the horizontal blade assembly 2 includes a horizontal blade linkage link 25 that may be simultaneously fitted to the link shaft 29 of the horizontal blades 22, 23, 24 to effect linkage of the three horizontal blades 22, 23, 24 (see FIGS. 3A-3C and 11C-11D). As indicated schematically, the horizontal blade assembly 2 includes a horizontal blade drive link 26, one end may be provided with a hole 261 for fitting to the link shaft 29 of the horizontal blade 23 passing through the horizontal blade linkage link 25; the other end may be provided with a shaft 262 which passes through a first slide groove 131 of the partition wall 13 and may be fitted to the dial lever assembly 5 (see FIG. 4B), where by the rotation of the horizontal blades 22, 23, 24 is driven by the dial lever assembly 5.

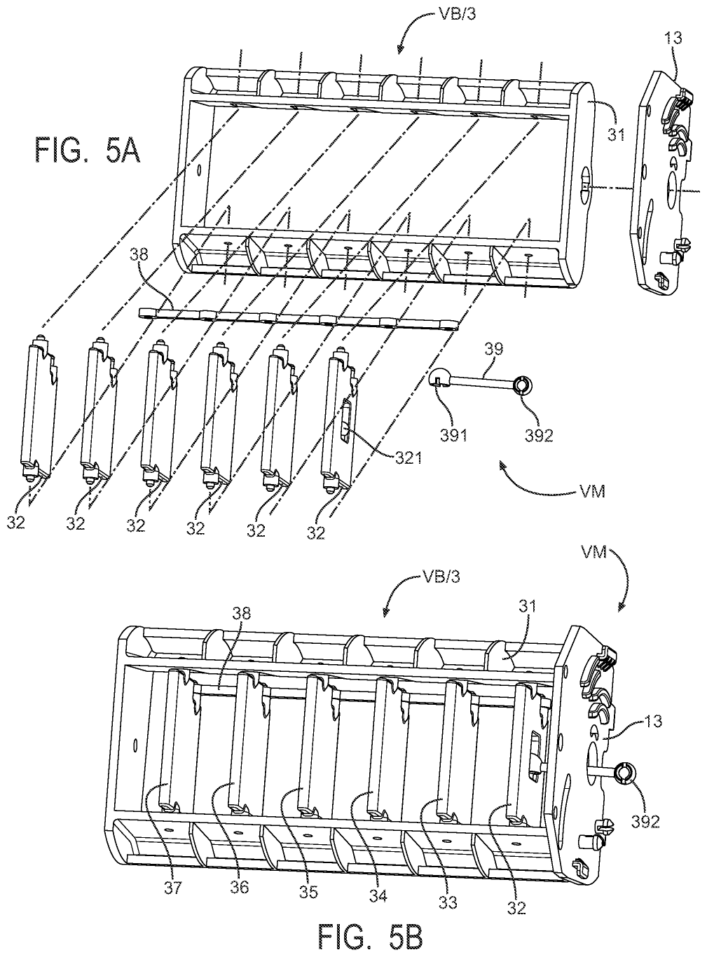

As shown schematically according to an exemplary embodiment in FIGS. 5A-5B, the perpendicular blade assembly 3 includes a perpendicular blade drum 31 and a plurality of perpendicular blades 32, 33, 34, 35, 36, 37, the perpendicular blade drum 31 has a left-side shaft fitted to a left side wall 121 (see FIG. 2B) of the rear half-housing 12; and a right-side shaft fitted to the partition wall 13; and both ends of the perpendicular blades 32, 33, 34, 35, 36, 37 are shaft-fitted to the perpendicular blade drum 31. As indicated schematically, the perpendicular blade assembly 3 includes a perpendicular blade linkage link 38 that may be simultaneously connected with the perpendicular blades 32, 33, 34, 35, 36, 37 to effect linkage of the six perpendicular blades 32, 33, 34, 35, 36, 37 (see FIGS. 3D-3E and 11A-11B). As indicated schematically, the perpendicular blade assembly 3 includes a perpendicular blade drive link 39 having a ball socket 391 at the left end fitted to the ball head 321 of the closest perpendicular blade 32 such that the perpendicular blade drive link 39 can pull the perpendicular blade 32 or rotate relative to the perpendicular blade 32; and a ball socket 392 at the right end fitted to the dial lever assembly 5 to drive the rotation of the perpendicular blades 32, 33, 34, 35, 36, 37 by the dial lever assembly 5.

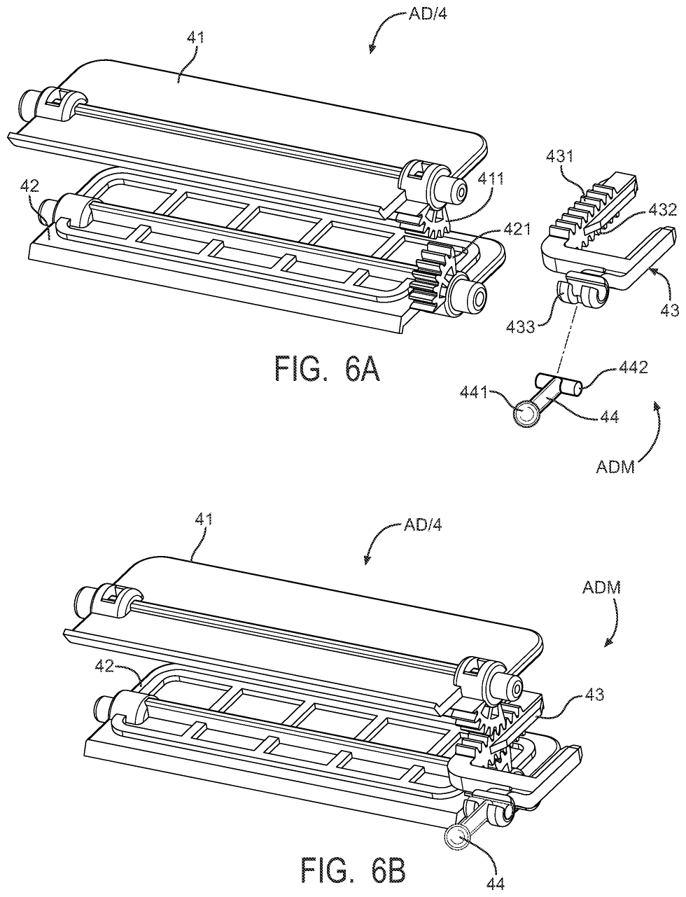

As shown schematically according to an exemplary embodiment in FIGS. 6A to 6B, the air door assembly 4 includes a first air door 41, a second air door 42 and an air door tooth bar 43; left and right sides of the first and second air doors 41 and 42 are respectively shaft-fitted to side walls of the rear half-housing 12; and the first and second air doors 41 and 42 are pivotably connected and have first and second gears 411 and 421, respectively, facing each other; and the air door tooth bar 43 may be inserted between the first gear 411 and the second gear 421 and has an upper tooth bar 431 and a lower tooth bar 432 oppositely arranged to cooperate with the first gear 411 and the second gear 421, respectively, so that the first air door 41 and the second air door 42 are rotated by the movement of the air door tooth bar 43 (see FIGS. 11E-11F). As indicated schematically, the air door assembly 4 may comprise an air door drive link 44; and a shaft rod 442 at one end of the air door drive link 44 may be connected with a shaft hole 433 on the air door tooth bar 43, so that the air door drive link 44 can pull the air door tooth bar 43 or deflect upward and downward relative to the air door tooth bar 43; the ball 441 at the other end of the air door drive link 44 may be fitted to the dial lever assembly 5, where by the rotation of the first air door 41 and the second air door 42 is driven by the dial lever assembly 5.

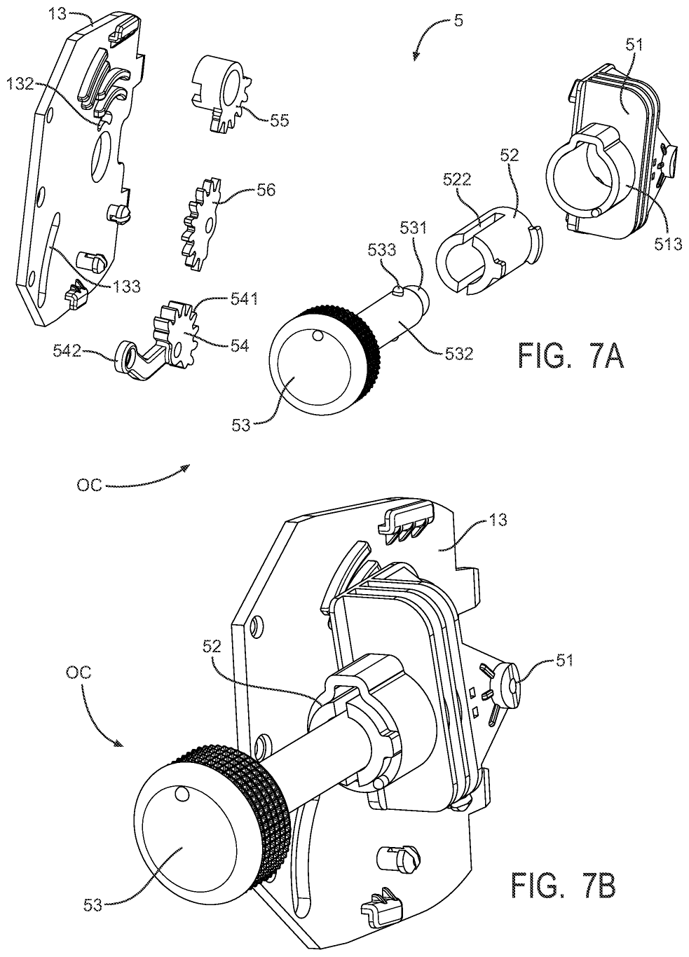

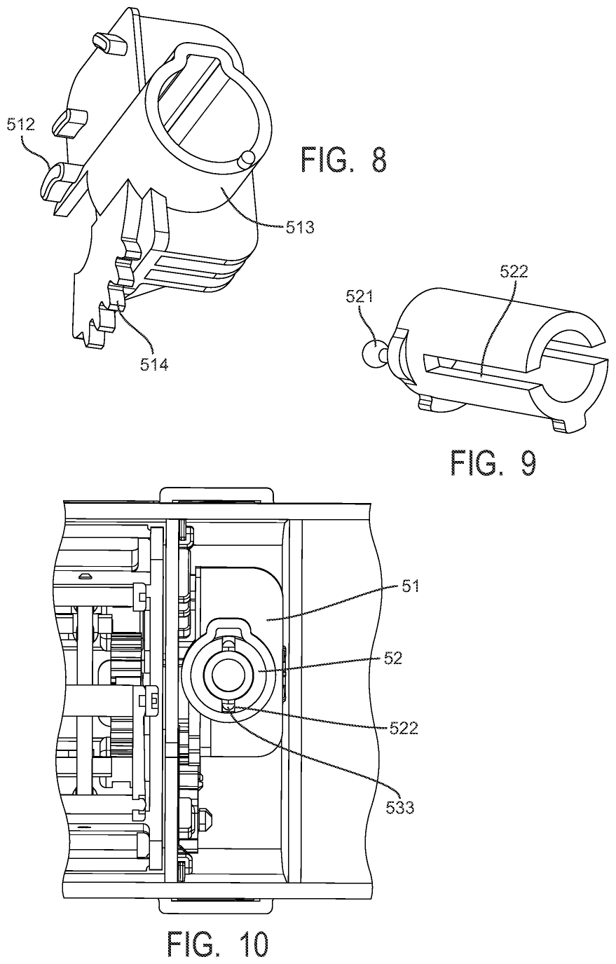

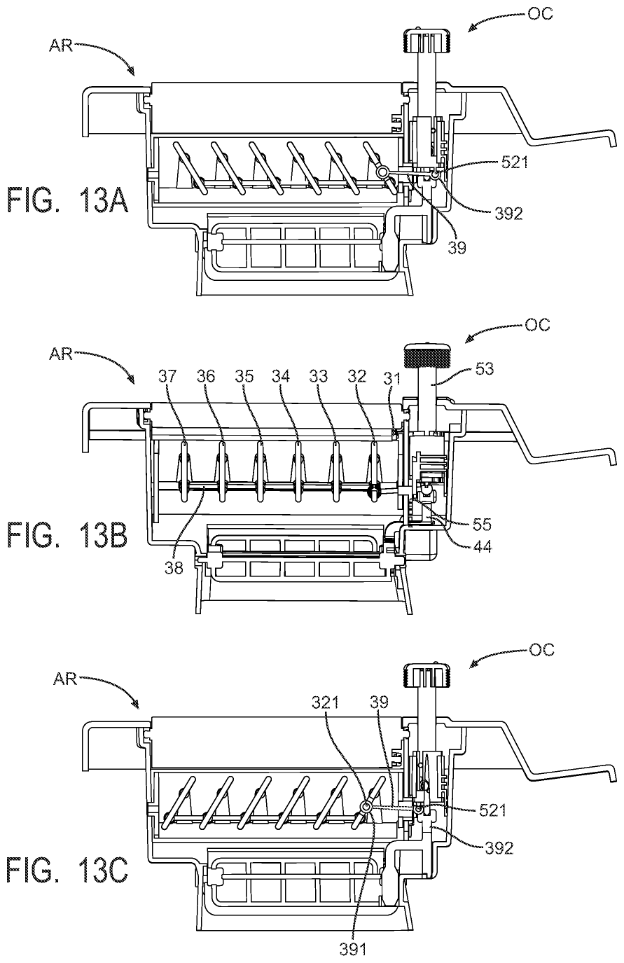

As shown schematically according to an exemplary embodiment in FIGS. 7A-7B, the dial lever assembly 5 includes an up-down toggle sleeve 51, a rotary sleeve 52 and a dial lever 53; the right end of the up-down toggle sleeve 51 may be connected with the rear half-housing 12 (see FIG. 2B) by a rotating shaft 511; and the left end may be provided with a pin 512 and a first tooth 514 (see FIG. 8); and the pin 512 may be inserted into a second slide groove 132 of the partition wall 13, so that upper and lower toggle sleeves 51 can rotate about the rotation shaft 511. The rotary sleeve 52 passes through a sleeve 513 of the up-down toggle sleeve 51 in the forward and backward directions; and the rotary sleeve 52 has a degree of freedom to rotate relative to the up-down toggle sleeve 51; and the rear end of the rotary sleeve 52 has a ball head 521 (see FIG. 9) which may be received in a ball socket 392 at the right end of the perpendicular blade drive link 39 (see FIGS. 5A, 13A and 13C), achieving that the dial lever assembly 5 drives the rotation of the perpendicular blades 32, 33, 34, 35, 36, 37. The shaft 532 of the dial lever 53 passes through the rotary sleeve 52 axially along the forward and backward directions and may be inserted into an open groove 522 of the wall surface of the rotary sleeve 52 through the pin 533 on the shaft 532 (refer to FIG. 10), so that the dial lever 53 has a degree of freedom to move forward and backward relative to the rotary sleeve 52 (refer to FIGS. 11E-11F); and the rear end of the shaft 532 may be provided with a ball socket 531 for receiving the ball head 441 of the air door drive link 44, achieving that the dial lever assembly 5 drives the rotation of the first air door 41 and the second air door 42. As indicated schematically, the rotation of the dial lever 53 may be kept synchronous with the rotation of the rotary sleeve 52, the up-down toggle of the dial lever 53 may be kept synchronous with the up-down toggle of the up-down toggle sleeve 51; and the retracting and extending of the dial lever 53 may be kept independent from the up-down toggle sleeve 51 and the rotary sleeve 52 (i.e. not influenced from each other).

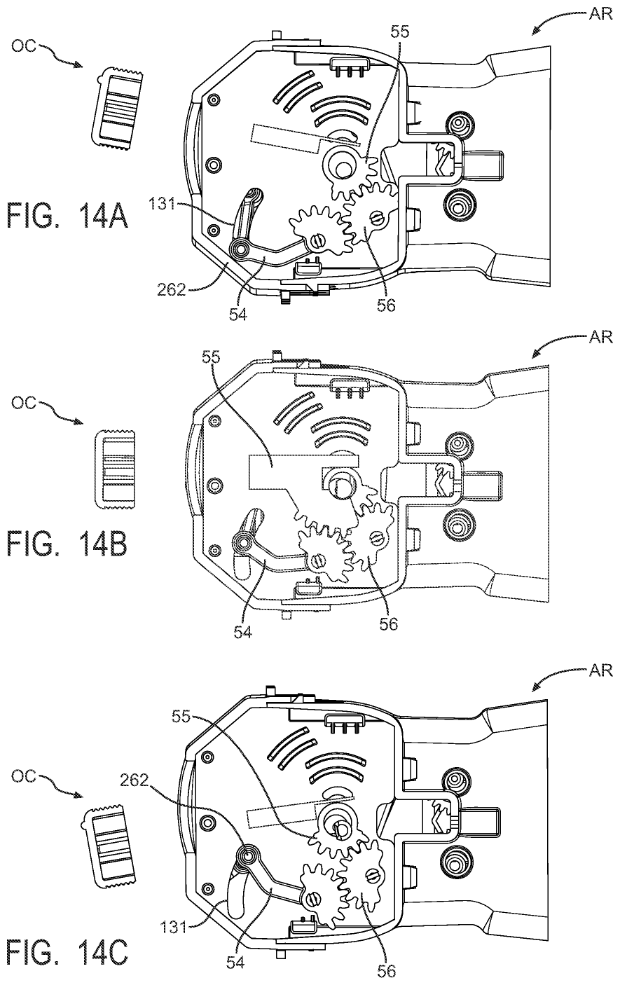

As shown schematically in FIG. 7A, the dial lever assembly 5 includes a horizontal blade drive gear 54 rotatably fitted on a corresponding mounting shaft 133 of the partition wall 13. As indicated schematically, the rear end of the horizontal blade drive gear 54 has a second tooth 541 engaged with the first tooth 514 (see FIG. 8) positioned on the up-down toggle sleeve 51, the front end of the horizontal blade drive gear 54 has a receiving hole 542; and a shaft 262 of the horizontal blade drive link 26 passes through the first slide groove 131 on the partition wall 13 and is inserted into and fits with a receiving hole 542 (see FIG. 7A) so as to drive the rotation of the horizontal blade drive gear 54 by moving up and down the up-down toggle sleeve 51; and then transmit the motion to the horizontal blade linkage link 25 through the shaft 262 of the horizontal blade drive link 26, driving the rotation of the horizontal blades 22, 23, 24. The dial lever assembly 5 includes a vertical drum connecting gear 55 connected with the perpendicular blade drum 31 through the partition wall 13 (see FIG. 7A) partially and a vertical drum conversion gear 56 rotatably fitted on a corresponding mounting shaft 134 of the partition wall 13; the vertical drum conversion gear 56 may be engaged with the second tooth 541 of the horizontal blade drive gear 54; and the vertical drum connecting gear 55 may be engaged with the vertical drum conversion gear 56 (see FIGS. 7A and 14A-14C), so that the rotation of the vertical drum conversion gear 56, the rotation of the vertical drum connecting gear 55; and finally the rotation of the perpendicular blade drum 31 can be driven by the rotation of the horizontal blade drive gear 54. As indicated schematically, by the arrangement of the vertical drum conversion gear 56, the rotation direction of the perpendicular blade drum 31 may be opposite to the rotation direction of the horizontal blades 22, 23, 24.

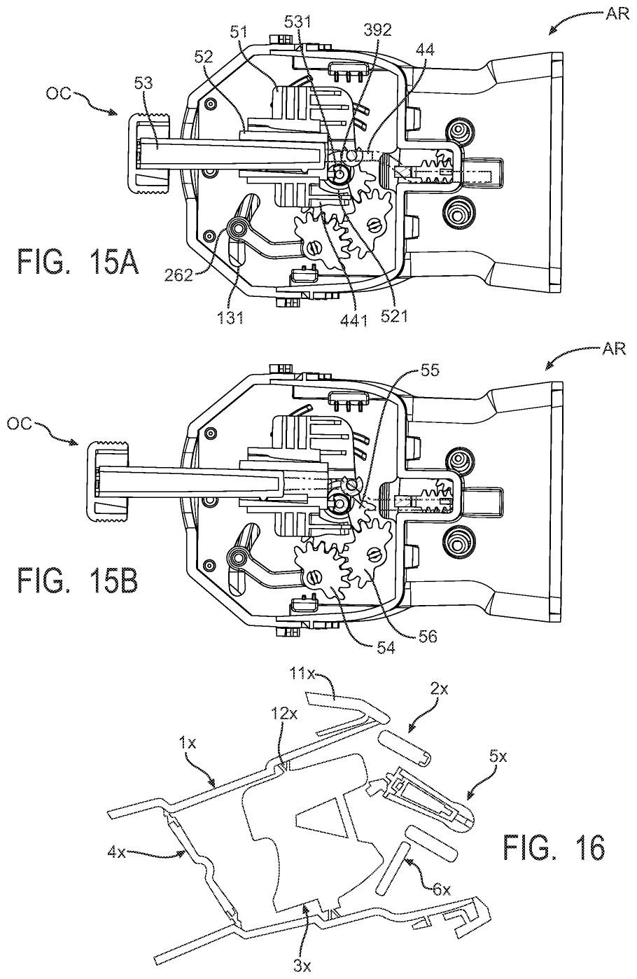

When the dial lever 53 is rotated, the rotary sleeve 52 may be driven for rotation; and the perpendicular blades 32, 33, 34, 35, 36, 37 are driven for rotation by the perpendicular blade drive link 39 connected with the rotary sleeve 52; when the dial lever 53 is shifted up and down in the vertical direction, the up-down toggle sleeve 51 may be driven for rotation; and the vertical drum connecting gear 55 may be driven by the horizontal blade drive gear 54 connected with the up-down toggle sleeve 51, while the perpendicular blade drum 31 and the horizontal blades 22, 23 and 24 are driven for rotation. The cooperation of the ball socket 392 of the perpendicular blade drive link 39 with the ball head 521 of the rotary sleeve 52 prevents the perpendicular blades 32, 33, 34, 35, 36, 37 from shifting up and down. As indicated schematically, the cooperation of the ball head 441 of the air door drive link 44 with the ball socket 531 of the up-down dial lever 53 (see FIGS. 15A-15B) makes the first air door 41 and the second air door 42 unaffected by the rotation and up-down toggling of the dial lever 53.

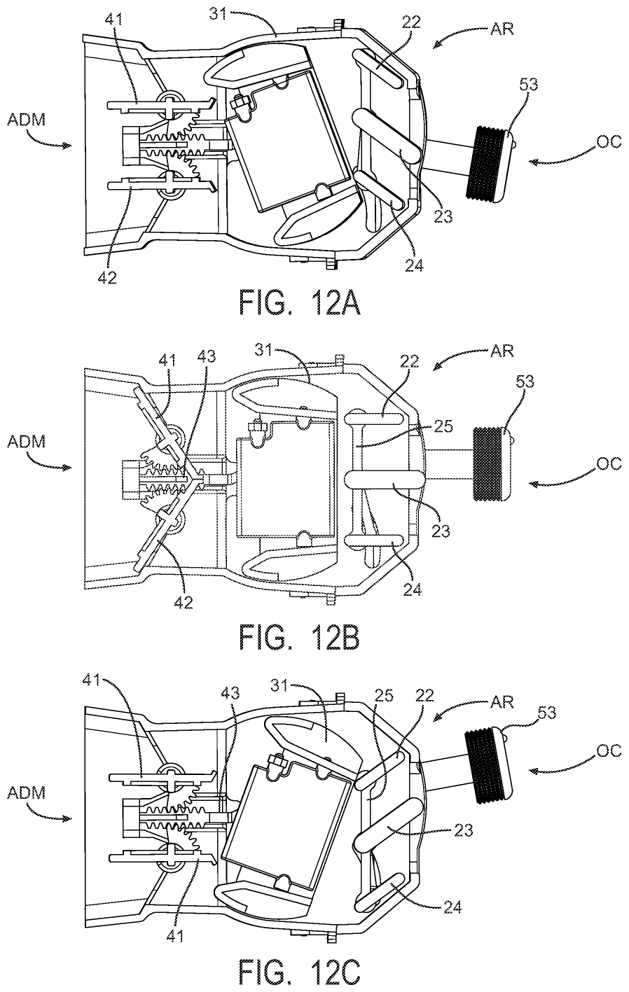

As shown schematically in FIG. 3B, when the dial lever 53 is in an initial position, the horizontal blades 22, 23, 24 are in the horizontal position; and one horizontal blade 23 can be seen by occupants; as shown schematically in FIG. 12B, the perpendicular blade drum 31 does not rotate; and the first air door 41 and the second air door 42 are in a closed state; as shown schematically in FIG. 13B, the perpendicular blades 32, 33, 34, 35, 36, 37 are in an initial position; as shown schematically in FIG. 14B, the shaft 262 of the horizontal blade drive link 26 is in an intermediate position of the first slide groove 131.

As shown schematically in FIG. 15B, when the dial lever 53 is pulled outward, the movement of the air door tooth bar 43 may be driven for movement by the air door drive link 44 connected with the dial lever 53; and then the counterclockwise rotation of the first air door 41 and the clockwise opening of the second air door 42 are controlled by the engagement of the upper tooth bar 431 and the lower tooth bar 432 positioned on the air door tooth bar 43 with the first gear 411 and the second gear 421 positioned on the first air door 41 and the second air door 42, respectively. The extending stroke of the dial lever 53 may be freely adjustable to control the opening degrees of the first air door 41 and the second air door 42. As shown schematically in FIG. 14C, when the dial lever 53 is shifted downward, the up-down toggle sleeve 51 may be driven to rotate counterclockwise; and the horizontal blade drive gear 54 may be rotated clockwise, so that the shaft 262 moves from a middle position to a high position in the first slide groove 131; and the horizontal blades 22, 23, 24 are deflected upward around the left-side shaft 27 and the right-side shaft 28 to realize downward inclination of the horizontal blades 22, 23, 24 with respect to the horizontal position. The occupants can see the horizontal blades 23, 24. As indicated schematically, the horizontal blade drive gear 54 drives the vertical drum connecting gear 55 to rotate clockwise by the vertical drum conversion gear 56; and then drives the perpendicular blade drum 31 to incline upward relative to the horizontal position. As indicated schematically, the downward blowing effect of the air outlet may be realized. As indicated schematically, when the dial lever 53 is shifted upward (see FIG. 14A), the up-down toggle sleeve 51 may be driven to rotate clockwise; and the horizontal blade drive gear 54 rotates counterclockwise, so that the shaft 262 moves from the middle position to the low position in the first slide groove 131; and the horizontal blades 22, 23, 24 deflect downward about the left-side shaft 27 and the right-side shaft 28 to incline the horizontal blades 22, 23, 24 upward with respect to the horizontal position. The occupants can see the horizontal blades 22, 23. As indicated schematically, the horizontal blade drive gear 54 drives the vertical drum connecting gear 55 to rotate counterclockwise by the vertical drum conversion gear 56; and then drives the perpendicular blade drum 31 to incline downward relative to the horizontal position. As indicated schematically, the upward blowing effect of the air outlet may be realized.

As shown schematically in FIG. 13C, when the dial lever 53 is rotated clockwise, the ball head 521 positioned on the rotary sleeve 52 may be driven to rotate clockwise; and the perpendicular blade linkage link 38 may be driven to move leftward by the cooperation of the ball head 521 and the ball socket 392, so that the perpendicular blades 32, 33, 34, 35, 36, 37 pivot rightward. As shown schematically in FIG. 13A, when the dial lever 53 is rotated counterclockwise, the ball head 521 positioned on the rotary sleeve 52 may be driven to rotate counterclockwise; and the perpendicular blade linkage link 38 may be driven to move rightward by the cooperation of the ball head 521 and the ball socket 392, so that the perpendicular blades 32, 33, 34, 35, 36, 37 pivot leftward.

As shown schematically according to an exemplary embodiment in FIGS. 17A to 17B, the air outlet structure; includes a housing 10, a horizontal blade assembly 20, a perpendicular blade assembly 30, an air door assembly 40; and a dial lever assembly 50; the horizontal blade assembly 20 may be installed at the front end of the housing 10, the perpendicular blade assembly 30 may be installed at the middle of the housing 10; and the air door assembly 40 may be installed at the rear end of the housing 10; a dial lever assembly 50 may be mounted to the housing 10 on the sides of the horizontal blade assembly 20 and the perpendicular blade assembly 30; and includes an air door dial lever 53 and a dial lever 520 sleeved on the air door dial lever 530; and the up-down toggle of the air door dial lever 530 or the dial lever 520 may drive rotation of the horizontal blades of the horizontal blade assembly 20 (as shown schematically according to an exemplary embodiment in FIGS. 18A-18C and 26C-26D); and the rotation of the dial lever 520 may drive rotation of the perpendicular blades of the perpendicular blade assembly 30 (as shown schematically according to an exemplary embodiment in FIGS. 18D-18E and 26A-26B); and the rotation of the air door dial lever 530 may drive the opening and closing of the air door of the air door assembly 40 (as shown schematically according to an exemplary embodiment in FIGS. 26E-26F).

The housing 10 includes a front half-housing 110 and a rear half-housing 120, which are relatively fixed (e.g. by a circumferential rim/snap-fit) to define a receiving cavity for receiving the horizontal blade assembly 20, the perpendicular blade assembly 30, the air door assembly 40; and at least a portion of the dial lever assembly 50. According to an exemplary embodiment, the housing 10 includes a partition wall 130 fixedly provided between the front half-housing 110 and the rear half-housing 120 and dividing the receiving cavity into a left cavity in which the horizontal blade assembly 20 and the perpendicular blade assembly 30 are received and a right cavity in which at least part of the dial lever assembly 50 may be received.

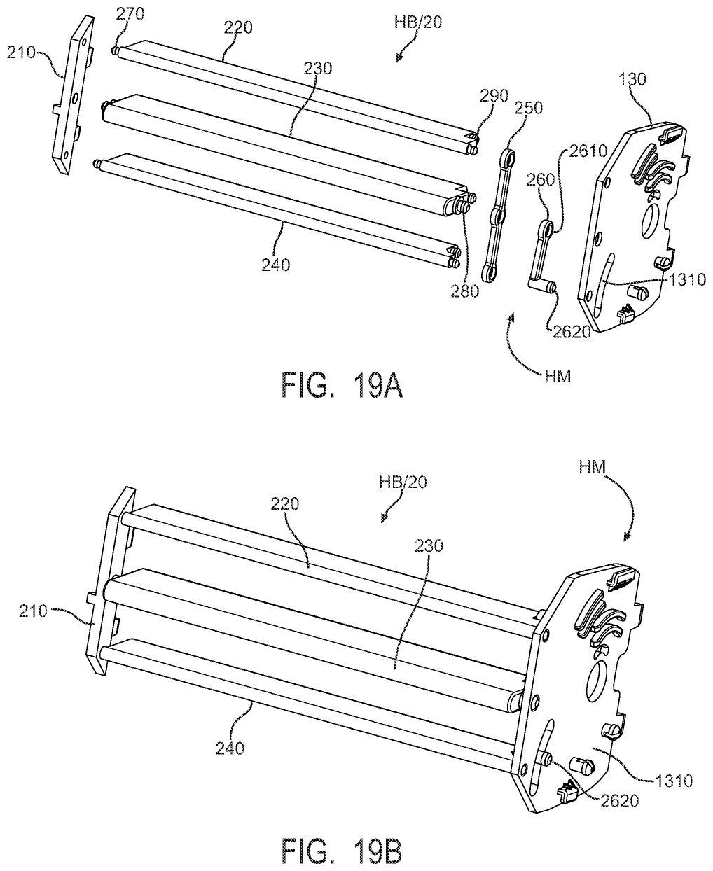

As shown schematically according to an exemplary embodiment in FIGS. 19A-19B, the horizontal blade assembly 20 includes a horizontal blade support 210 and a plurality of horizontal blades 220, 230, 240, each of the horizontal blades 220, 230, 240 includes a left-side shaft 270 on the left side and a right-side shaft 280 and a link shaft 290 on the right side. The left-side shaft 270 and the right-side shaft 280 are coaxial and closer to the outer side of the air outlet opening than the link shaft 290. The left-side shaft 270 of the horizontal blades 220, 230, 240 may be fitted to the horizontal blade support 210 fixed to the housing 10; and the right-side shaft 280 may be fitted to the partition wall 130. As indicated schematically, the horizontal blade assembly 20 includes a horizontal blade linkage link 250 that may be simultaneously fitted to the link shaft 290 of the horizontal blades 220, 230, 240 to effect linkage of the three horizontal blades 220, 230, 240 (see FIGS. 18A-18C and 26C-26D). As indicated schematically, the horizontal blade assembly 20 includes a horizontal blade drive link 260, one end may be provided with a hole 2610 for fitting to the link shaft 290 of the horizontal blade 230 passing through the horizontal blade linkage link 250; the other end may be provided with a shaft 2620 which passes through a first slide groove 1310 of the partition wall 130 and is fitted to the dial lever assembly 50 (see FIG. 19B), where by the rotation of the horizontal blades 220, 230, 240 is driven by the dial lever assembly 50.

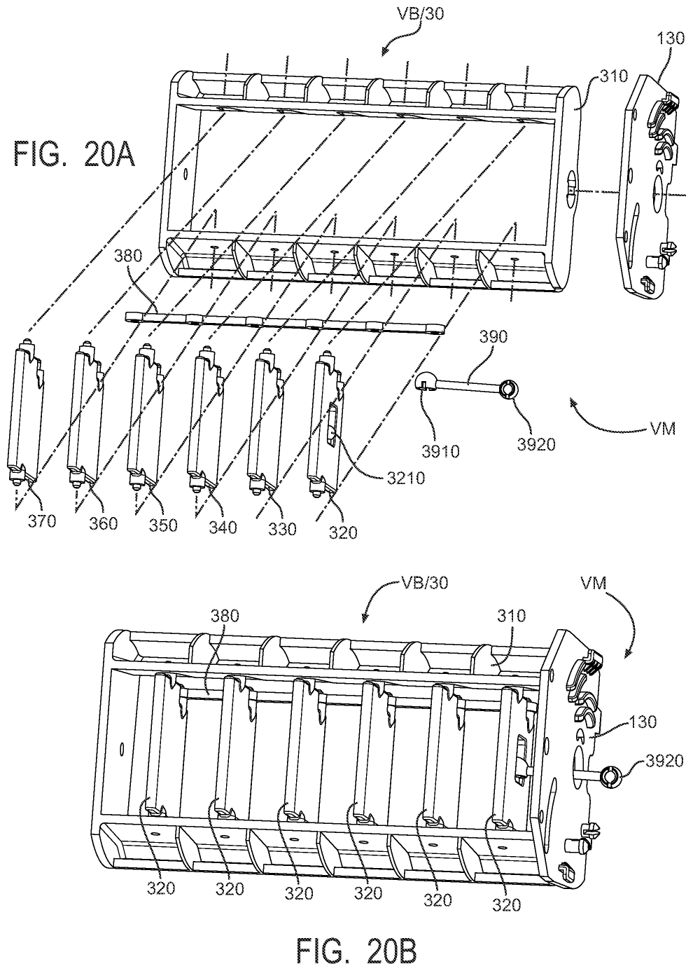

As shown schematically according to an exemplary embodiment in FIGS. 20A-20B, the perpendicular blade assembly 30 includes a perpendicular blade drum 310 and a plurality of perpendicular blades 320, 330, 340, 350, 360, 370, the perpendicular blade drum 310 has a left-side shaft fitted to a left side wall 1210 (see FIG. 17B) of the rear half-housing 120; and a right-side shaft fitted to the partition wall 130; and both ends of the perpendicular blades 320, 330, 340, 350, 360, 370 are shaft-fitted to the perpendicular blade drum 310. As indicated schematically, the perpendicular blade assembly 30 includes a perpendicular blade linkage link 380 that may be simultaneously connected with perpendicular blades 320, 330, 340, 350, 360, 370 to effect linkage of the six perpendicular blades 320, 330, 340, 350, 360, 370 (see FIGS. 18D-18E and 26A-26B). As indicated schematically, the perpendicular blade assembly 30 includes a perpendicular blade drive link 390 having a ball socket 3910 at the left end fitted to the ball head 3210 of the closest perpendicular blade 320 such that the perpendicular blade drive link 390 can pull the perpendicular blade 320 or rotate relative to the perpendicular blade 320; and a ball socket 392 at the right end fitted to the dial lever assembly 500 to drive the rotation of the perpendicular blades 320, 330, 340,350, 360, 370 by the dial lever assembly 50.

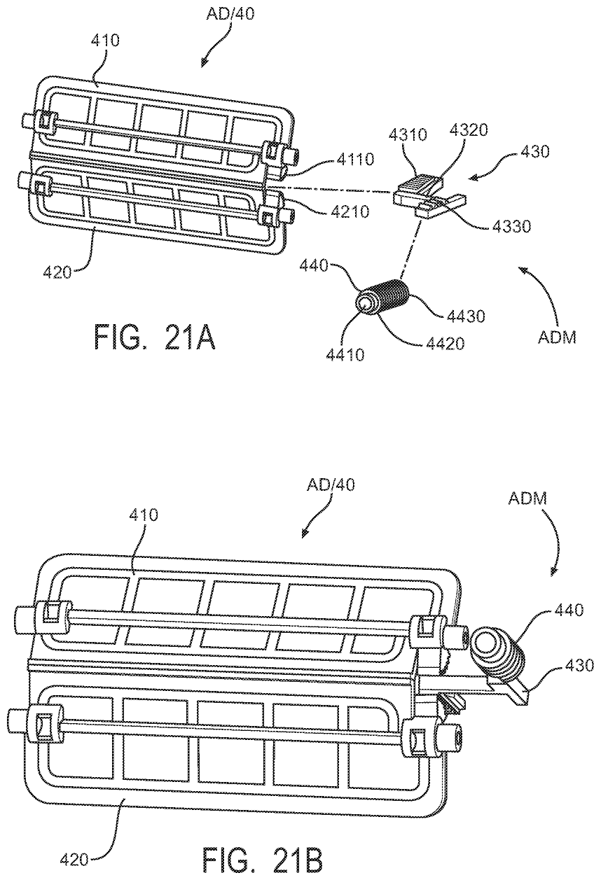

As shown schematically according to an exemplary embodiment in FIGS. 21A-21B, the air door assembly 40 includes a first air door 410, a second air door 420 and an air door tooth bar 430; left and right sides of the first and second air doors 410 and 420 are shaft-fitted to side wall of the rear half-housing 120 respectively, the first and second air doors 410 and 420 are pivotably connected and have a first gear 4110 and a second gear 4210 facing each other, respectively; and an air door tooth bar 430 is inserted between the first gear 4110 and the second gear 4210 and has an upper gear tooth bar 4310 and a lower gear tooth bar 4320 oppositely arranged to cooperate therewith so as to rotate the first air door 410 and the second air door 420 by the movement of the air door tooth bar 430 (see FIGS. 26E-26F). As indicated schematically, the air door assembly 40 includes an air door worm/gear/gear 440, one end may be connected with the air door tooth bar 430; and the other end may be fitted to the dial lever assembly 50, driving the rotation of the first and second air doors 410 and 420 by the dial lever assembly 50.

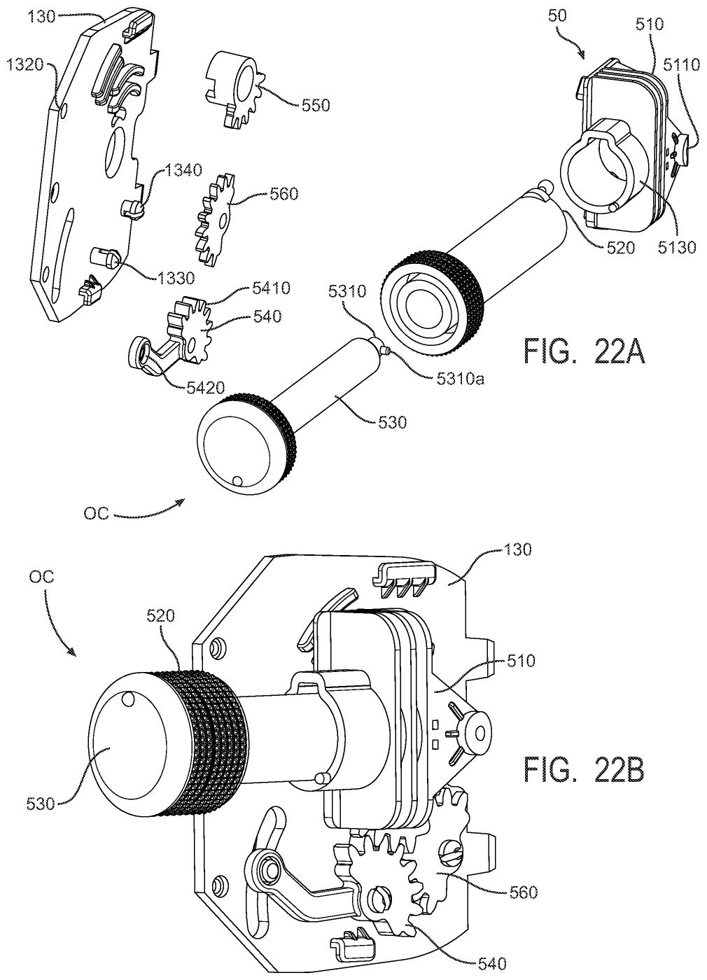

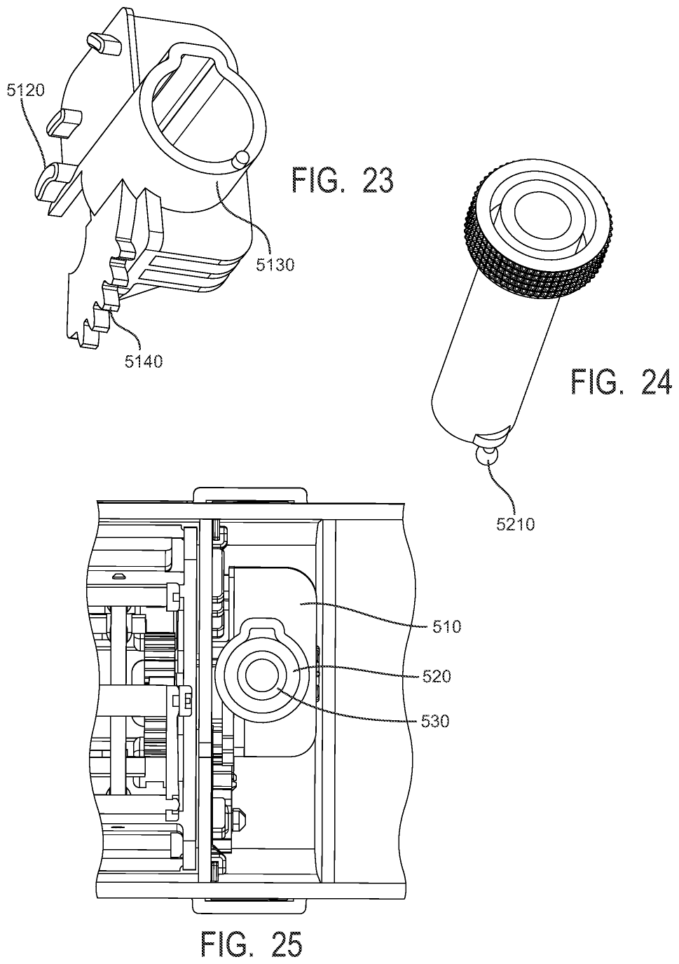

As shown schematically according to an exemplary embodiment in FIGS. 22A-22B, the dial lever assembly 50 includes an up-down toggle sleeve 510, a dial lever 520 and an air door dial lever 530; the right side of the up-down toggle sleeve 510 may be connected with the rear half-housing 120 (see FIG. 17B) by a rotating shaft 5110; and the left side may be inserted into the second slide groove 1320 of the partition wall 130 by a pin 5120 (see FIG. 23) to rotate the up-down toggle sleeve 510 about the rotating shaft 5110. The left end of the up-down toggle sleeve 510 includes a first tooth 5140 (shown schematically in FIG. 23). The dial lever 520 passes through the sleeve 5130 of the up-down toggle sleeve 510 in the forward and backward directions such that the dial lever 520 has a degree of freedom to rotate relative to the up-down toggle sleeve 510; and the rear end of the dial lever 520 has a ball head 5210 (see FIG. 24) received in a ball socket 3920 at the right end of the perpendicular blade drive link 390 (see FIG. 20A). As indicated schematically, the rotation of the dial lever 520 can drive the movement of the perpendicular blade drive link 390, which causes rotation of the perpendicular blades 320, 330, 340, 350, 360, 370. The air door dial lever 530 passes through the dial lever 520 in the front-rear direction and enables the air door dial lever 530 to have a degree of freedom to rotate relative to the dial lever 520 (see FIGS. 22B and 25). As indicated schematically, the rotation of the air door dial lever 530 and the rotation of the dial lever 520 remain independent (i.e., do not affect each other); and the up-down toggling of the air door dial lever 530 may be synchronized with the up-down toggling of the up-down toggle sleeve 510 via the dial lever 520. The rear end of the air door dial lever 530 has a ball head 5310 and a protrusion 5310a protruding from the side of the ball head 5310, the ball head 5310 may be received in a ball socket 4410 at the front end of the air door worm/gear/gear 440 (see FIG. 21A) and engaged with a groove 4420 in the ball socket 4410 through a protrusion 5310a, so that the air door dial lever 530 can rotate the air door worm/gear/gear 440 synchronously.

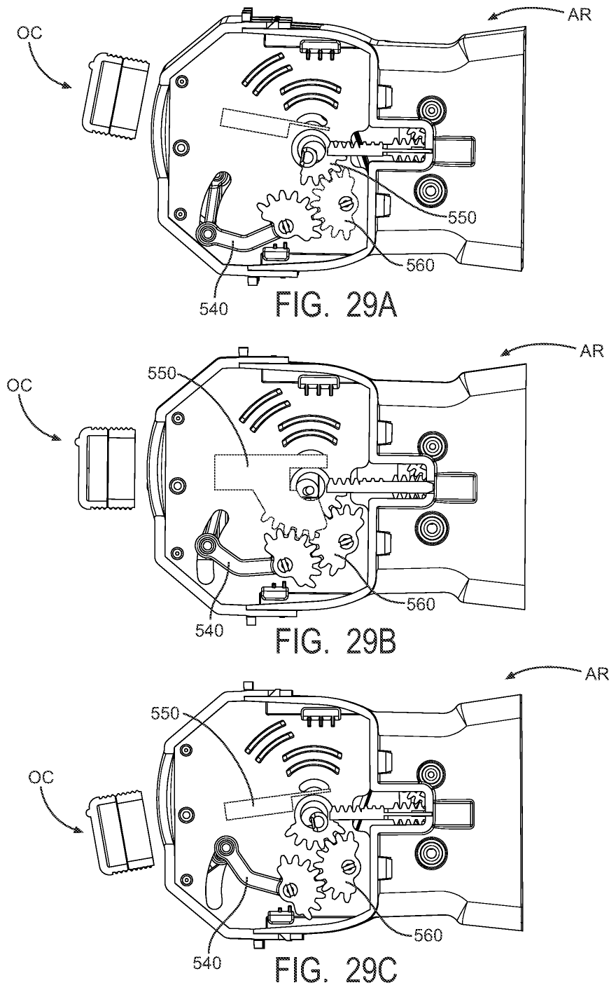

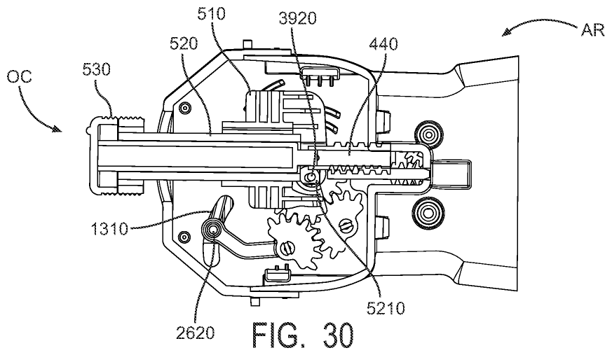

As shown schematically in FIG. 22A, the dial lever assembly 50 includes a horizontal blade drive gear 540 rotatably fitted on a corresponding mounting shaft 1330 of the partition wall 130. As indicated schematically, the rear end of the horizontal blade drive gear 540 has a second tooth 5410 (see FIG. 22A) engaged with the first tooth 5140 on the up-down toggle sleeve 510, the front end of the horizontal blade drive gear 540 has a receiving hole 5420; and the shaft 2620 of the horizontal blade drive link 260 passes through the first slide groove 1310 on the partition wall 130 and inserts into and fits with the receiving hole 5420 (see FIG. 22B) so as to drive the rotation of the horizontal blade drive gear 540 by the up-down toggle of the up-down toggle sleeve 510; and then transmit the motion to the horizontal blade linkage link 250 through the shaft 2620 of the horizontal blade drive link 260, driving the rotation of the horizontal blades 220, 230, 240. The dial lever assembly 50 includes a vertical drum connecting gear 550 connected with the perpendicular blade drum 310 (see FIGS. 20A and 22A) by the partition wall 130; and a vertical drum conversion gear 560 rotatably fitted to a corresponding mounting shaft 1340 of the partition wall 130; the vertical drum conversion gear 560 may be engaged with the second tooth 5410 of the horizontal blade drive gear 540; and the vertical drum connecting gear 550 may be engaged with the vertical drum conversion gear 560 (see FIGS. 22A and 29A-29C), so that the rotation of the vertical drum conversion gear 560, the rotation of the vertical drum connecting gear 550; and finally the rotation of the perpendicular blade drum 310 can be driven by the rotation of the horizontal blade drive gear 540. As indicated schematically, by the arrangement of the vertical drum conversion gear 560, the rotation direction of the perpendicular blade drum 310 may be opposite to the rotation direction of the horizontal blades 220, 230, 240.

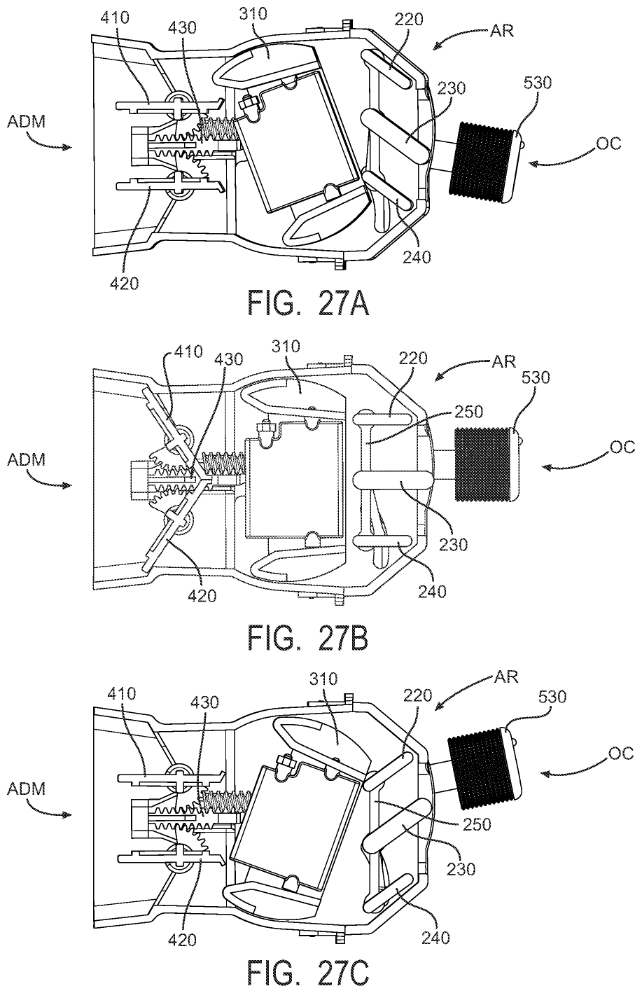

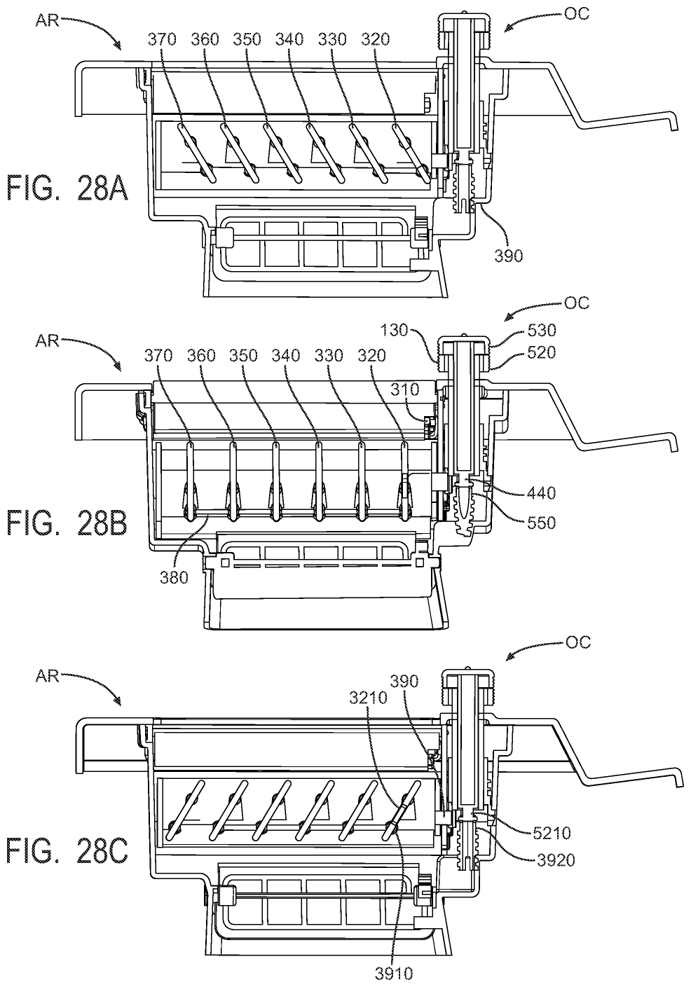

As shown schematically in FIG. 27B, when the air door dial lever 530 and the dial lever 520 are in initial positions and the horizontal blades 220, 230, 240 are in horizontal positions, occupants can see the horizontal blades 230; the perpendicular blade drum 310 does not rotate; and the first air door 410 and the second air door 420 are in a closed state; the perpendicular blades 320, 330, 340, 350, 360, 370 are in initial positions, as shown schematically in FIG. 28B; and the shaft 2620 of the horizontal blade drive link 260 may be in an intermediate position of the first slide groove 1310, as shown schematically in FIG. 29B.

As shown schematically in FIG. 26E, when the air door dial lever 530 is rotated rightward; and the air door dial lever 530 rotates the air door worm/gear/gear 440 clockwise, so that threads 4430 on the air door worm/gear 440 cooperate with the tooth 4330 on the air door tooth bar 430 to move the air door tooth bar 430 forward (see FIG. 21A). The first air door 410 is then controlled to rotate counterclockwise and the second air door 420 is opened clockwise by engagement of the upper and lower tooth bars 4310 and 4320 on the air door tooth bar 430 with the first and second gears 4110 and 4210 on the first and second air doors 410 and 420, respectively. The rotational stroke of the air door dial lever 530 may be freely adjustable to control the opening degrees of the first air door 410 and the second air door 420. As shown schematically in FIG. 27A, when the air door dial lever 530 or the dial lever 520 is shifted downward, the up-down toggle sleeve 510 may be driven to rotate counterclockwise; and the horizontal blade drive gear 540 may be rotated clockwise, so that the shaft 2620 moves from a middle position to a high position in the first slide groove 1310, the horizontal blades 220, 230, 240 are deflected upward about the left-side shaft 270 and the right-side shaft 280 to realize downward inclination of the horizontal blades 220, 230, 240 with respect to the horizontal position. The occupants can see the horizontal blades 230, 240. As indicated schematically, the horizontal blade drive gear 540 drives the vertical drum connecting gear 550 to rotate clockwise by the vertical drum conversion gear 560; and then drives the perpendicular blade drum 310 to incline upward relative to the horizontal position (see FIG. 26D). As indicated schematically, the downward blowing effect of the air outlet can be realized. As indicated schematically, when the dial lever 530 or the dial lever 520 is shifted upward, as shown schematically in FIG. 27B, the up-down toggle sleeve 510 may be driven to rotate clockwise; and the horizontal blade drive gear 540 may be rotated counterclockwise, so that the shaft 2620 is moved from the middle position to the low position in the first slide groove 1310; and the horizontal blades 220, 230, 240 are deflected downward about the left-side shaft 270 and the right-side shaft 280 to incline the horizontal blades 220, 230, 240 upward with respect to the horizontal position. The occupant can see the horizontal blades 220, 230. As indicated schematically, the horizontal blade drive gear 540 drives the vertical drum connecting gear 550 to rotate counterclockwise by the vertical drum conversion gear 560; and then drives the perpendicular blade drum 310 to incline downward relative to the horizontal position (see FIG. 26C). As indicated schematically, the upward blowing effect of the air outlet can be realized.

As shown schematically in FIG. 28C, by rotating the dial lever 520 to the right, the dial lever 520 moves rightward the perpendicular blade drive link 390 by the combination of the ball head 5210 and the ball socket 3920 on the perpendicular blade drive link 390, which pivots rightward the perpendicular blades 320, 330, 340, 350, 360, 370. Conversely, as shown schematically in FIG. 28A, by rotating the dial lever 520 to the left, the dial lever 520 moves leftward the perpendicular blade drive link 390 by the combination of the ball head 5210 and the ball socket 3920 on the perpendicular blade drive link 390, which moves leftward the perpendicular blades 320, 330, 340, 350, 360, 370.

### Exemplary Embodiments—B

An air outlet structure providing a channel for airflow may comprise (a) a housing, (b) a vertical guide configured to guide the airflow (c) a horizontal guide configured to guide the airflow, and (d) a dial lever assembly configured to move the vertical guide and the horizontal guide; the dial lever assembly may be configured to move the vertical guide between left and right positions; the dial lever assembly may be configured to move the horizontal guide between upper and lower positions; the dial lever assembly may be configured to (1) move the horizontal guide by rotating relative to the housing about a first axis parallel to an extension direction of the horizontal guide; and (2) move the vertical guide by rotating relative to the housing about a second axis perpendicular to both the extension direction of the horizontal guide and the extension direction of the vertical guide.

As indicated schematically, the air outlet structure may comprise an air door configured to move between a closed position closing the channel and an open position allowing the airflow therethrough. As indicated schematically, the dial lever assembly may be configured such that the horizontal guide and the vertical guide are configured to remain in a position relative to the housing when the air door moves between the closed position and the open position. As indicated schematically, the dial lever assembly may be configured to translate in the direction of the second axis relative to the housing to move the air door between the closed position and the open position. As indicated schematically, the dial lever assembly may comprise a dial lever configured to move the vertical guide by rotating about the second axis relative to the housing and an air door dial lever configured to move the air door by rotating about the second axis relative to the housing.

As indicated schematically, the vertical guide may be configured as one of front and rear rows of blades; the horizontal guide may be configured as the other one of the front and rear rows of blades. As indicated schematically, the dial lever assembly may comprise an up-down toggle sleeve and a rotary sleeve; the up-down toggle sleeve may be rotatably mounted on the housing about a first direction; and one of the front and rear rows of blades may be connected with the up-down toggle sleeve; and the rotary sleeve may be rotatable about a second direction relative to the up-down toggle sleeve, the second direction may be perpendicular to the first direction; and the other one of the front and rear rows of blades may be connected with the rotary sleeve.

As indicated schematically, the rotary sleeve passes through the up-down toggle sleeve and has a degree of freedom to rotate about the second direction relative to the up-down toggle sleeve. As indicated schematically, one of the front and rear rows of blades may be connected with the up-down toggle sleeve by a first blade drive gear, one of the front and rear rows of blade assemblies has a first blade drive link with a shaft; and one end of the first blade drive gear may be connected with the shaft; and the up-down toggle sleeve has a first tooth; and the other end of the first blade drive gear may be engaged with the first tooth. As indicated schematically, the other one of the front and rear rows of blades may be connected with the rotary sleeve by a ball socket structure; and the other one of the front and rear rows of blade assemblies may be provided with a second blade drive link; the second blade drive link has a ball socket; and the rotary sleeve has a ball head; alternatively, the second blade drive link has a ball head; and the rotary sleeve has a ball socket; and the ball head may be received in the ball socket.

As indicated schematically, the air outlet structure may comprise an air door controlled by retracting and extending the dial lever assembly. As indicated schematically, the dial lever assembly may comprise a dial lever connected with the air door by passing through the rotary sleeve. As indicated schematically, the dial lever has a degree of freedom to move in the second direction relative to the rotary sleeve. As indicated schematically, the wall surface of the rotary sleeve may be provided with an opening groove extending forward and backward; and the dial lever has a pin which is movable in the opening groove. As indicated schematically, the dial lever assembly may comprise an up-down toggle sleeve rotatably mounted on the housing about a first direction; and one of the front and rear rows of blades may be connected with the up-down toggle sleeve; and the dial lever may be rotatable about a second direction relative to the up-down toggle sleeve, the second direction may be perpendicular to the first direction; and the other one of the front and rear rows of blades may be connected with the dial lever. As indicated schematically, the dial lever passes through the up-down toggle sleeve and has a degree of freedom to rotate relative to the up-down toggle sleeve.

As indicated schematically, one of the front and rear rows of blades has a first blade drive link and is connected with the up-down toggle sleeves by a first blade drive gear; and the first blade drive link has a shaft with which one end of the first blade drive gear is connected; and the up-down toggle sleeve has a first tooth; and the other end of the first blade drive gear is engaged with the first tooth. As indicated schematically, the other one of the front and rear rows of blades has a second blade drive link and is connected with the dial lever by a ball socket structure; the second blade drive link has a ball socket; and the dial lever has a ball head; alternatively, the second blade drive link has a ball head; and the dial lever has a ball socket; and the ball head is received in the ball socket.

As indicated schematically, the air outlet structure may comprise an air door, the dial lever assembly may comprise an air door dial lever inserted into the dial lever; and the air door is controlled by rotating the air door dial lever. As indicated schematically, the air door dial lever has a degree of freedom to rotate relative to the dial lever. As indicated schematically, the air door dial lever is connected with the air door by a worm/gear. As indicated schematically, one of the air door dial lever and the worm/gear may be provided with a ball socket, the other one may be provided with a ball head; and a convex point on the ball head is matched with a groove on the ball socket, so that the air door dial lever drives the rotation of the worm/gear.

As indicated schematically, an air outlet structure may comprise a dial lever assembly, a front row of blade assembly and a rear row of blade assembly mounted on a housing; a blade of one of the front row of blade assembly and the rear row of blade assembly is driven by shifting the dial lever of the dial lever assembly up and down; and a blade of the other one of the front row of blade assembly and the rear row of blade assembly is driven by rotating the dial lever of the dial lever assembly. As indicated schematically, the blade assembly is driven by the up-down toggle and rotation of the dial lever without the need to be driven by the conventional left-and-right shifting; the installation space can be greatly saved; and the blade assembly is suitable for an limited-space installation environment.

As indicated schematically, the housing may comprise a partition wall; and the front and rear rows of blade assemblies and the dial lever assembly are mounted on opposite sides of the partition wall, respectively. As indicated schematically, the dial lever assembly is positioned on the side surfaces of the front row of blade assembly and the rear row of blade assembly; the air blowing is prevented from being shielded; the air blowing effect is not influenced by the arrangement of the dial lever assembly.

As indicated schematically, the front row of blade assembly is a horizontal blade assembly; and the rear row of blade assembly is a perpendicular blade assembly. As indicated schematically, it is possible to provide the front row of blade assembly as a perpendicular blade assembly; and the rear row of blade assembly as a horizontal blade assembly. As indicated schematically, the front row of blades of the front row of blade assembly and the rear row of blades of the rear row of blade assembly may be perpendicular to each other or may form an included angle with each other, as desired. As indicated schematically, the front row of blade assembly may comprise at least one front row blade rotatably connected to the housing and a front row blade drive link connected to the front row of blades; and the front row blade drive link is connected to the dial lever assembly to drive rotation of the front row of blades by the dial lever assembly. As indicated schematically, the dial lever assembly may comprise an up-down toggle sleeve and a horizontal blade drive gear which are mounted on the housing (partition wall) and are meshed with each other, the up-down toggle sleeve is sleeved on the dial lever and has a degree of freedom to shift up and down synchronously with the dial lever but is irrelevant to the rotation of the dial lever; and the horizontal blade drive gear is connected with the front row blade drive link to drive the rotation of the front row of blades.

As indicated schematically, the rear row of blade assembly may comprise a rear row of blade drum rotatably connected to the housing, at least one rear row blade rotatably mounted on the rear row of blade drum; and a rear row blade drive link connected to the rear row of blades; and the rear row blade drive link is connected to the dial lever assembly to drive rotation of the rear row of blades by the dial lever assembly; and the rear row of blade drum and the front row of blade assembly are driven synchronously. As indicated schematically, the rear row of blades can rotate on the housing along with the rear row blade drum besides rotating on the rear row blade drum; and can be used for replacing the follow-up blades in the prior art to optimize the air guiding effect. As indicated schematically, the rear row of blades of the air outlet structure do not need to be cut off and moved backward, so that the installation space can be greatly saved; and the air outlet structure is suitable for limited installation environment.

As indicated schematically, the dial lever assembly may comprise a vertical drum connecting gear mounted on the housing (partition wall) and connected to the rear row blade drum, the vertical drum connecting gear is connected to a driving structure (horizontal blade drive gear) of the front row of blade assembly by a vertical drum conversion gear to synchronously drive the front row of blade assembly and the rear row blade drum (rotation of the front row of blades and the rear row blade drum). As indicated schematically, the dial lever assembly may comprise a rotary sleeve sleeved on the dial lever and having a degree of freedom to synchronously shift up and down and synchronously rotate with the dial lever; and the rotary sleeve has a ball head received in a ball socket structure of the rear row blade drive link.

As indicated schematically, the air outlet structure may comprise an air door assembly; the air door assembly is driven by retracting and extending a dial lever of the dial lever assembly.

As indicated schematically, the opening and closing of the air door are realized by retracting and extending the dial lever; operation the horizontal blade assembly, the perpendicular blade assembly and the air door is actuated at the dial lever/operator control; the installation space and cost are saved by the compact structure/assembly.

As indicated schematically, the air door assembly may comprise at least one air door rotatably connected to the housing, an air door tooth bar connected to the air door to drive the air door to rotate; and an air door drive link connected to the air door tooth bar; and the air door drive link is connected to the dial lever assembly to drive the opening and closing of the air door by the dial lever assembly. As indicated schematically, the rear end of the dial lever has a ball socket structure that receives the ball head of the air door drive link. As indicated schematically, the air door assembly may comprise first and second air doors connected pivotally and having first and second gears facing each other respectively, with an air door tooth bar interposed between the first and second gears and having oppositely disposed first and second tooth bars engaged with the first and second gears to rotate the first and second air doors by movement of the air door tooth bar.

As indicated schematically, the opening and closing of the front and rear rows of blades are independently controlled by different actions of the dial lever. As indicated schematically, the opening and closing of an air door can be independently controlled; the horizontal blades of the front row of blade assemblies rotate up and down by shifting a dial lever assembly up and down; the perpendicular blades of the rear row of blade assemblies rotate left and right by rotating the dial lever assembly; and the opening and closing of the air door are realized by retracting and extending the dial lever assembly; independent actuation at a single operator control achieves a compact arrangement of the space.

As indicated schematically, an air outlet structure providing a channel for airflow may comprise a housing, a vertical guide configured to guide the airflow, a horizontal guide configured to guide the airflow; and a dial lever assembly configured to move the vertical guide and the horizontal guide. The dial lever assembly may be configured to move the vertical guide between left and right positions. The dial lever assembly may be configured to move the horizontal guide between upper and lower positions. The dial lever assembly may be configured to (1) move the horizontal guide by rotating relative to the housing about a first axis parallel to an extension direction of the horizontal guide; and (2) move the vertical guide by rotating relative to the housing about a second axis perpendicular to both the extension direction of the horizontal guide and the extension direction of the vertical guide. The air outlet structure may comprise an air door configured to move between a closed position closing the channel and an open position allowing the airflow therethrough. The dial lever assembly may be configured such that the horizontal guide and the vertical guide are configured to remain in a position relative to the housing when the air door moves between the closed position and the open position. The dial lever assembly may be configured to translate in the direction of the second axis relative to the housing to move the air door between the closed position and the open position. The dial lever assembly may comprise a dial lever configured to move the vertical guide by rotating about the second axis relative to the housing and an air door dial lever configured to move the air door by rotating about the second axis relative to the housing. The vertical guide may be configured as one of front and rear rows of blades, the horizontal guide may be configured as the other one of the front and rear rows of blades. The dial lever assembly may comprise an up-down toggle sleeve and a rotary sleeve, the up-down toggle sleeve may be rotatably mounted on the housing about a first direction; and one of the front and rear rows of blades may be connected with the up-down toggle sleeve; and the rotary sleeve may be rotatable about a second direction relative to the up-down toggle sleeve, the second direction may be perpendicular to the first direction; and the other one of the front and rear rows of blades may be connected with the rotary sleeve. The rotary sleeve passes through the up-down toggle sleeve and has a degree of freedom to rotate about the second direction relative to the up-down toggle sleeve. One of the front and rear rows of blades may be connected with the up-down toggle sleeve by a first blade drive gear, one of the front and rear rows of blade assemblies has a first blade drive link with a shaft; and one end of the first blade drive gear may be connected with the shaft; and the up-down toggle sleeve has a first tooth; and the other end of the first blade drive gear may be engaged with the first tooth. The other one of the front and rear rows of blades may be connected with the rotary sleeve by a ball socket structure; and the other one of the front and rear rows of blade assemblies may be provided with a second blade drive link; the second blade drive link has a ball socket; and the rotary sleeve has a ball head; alternatively, the second blade drive link has a ball head; and the rotary sleeve has a ball socket; and the ball head may be received in the ball socket. The air outlet structure may comprise an air door controlled by retracting and extending the dial lever assembly. The dial lever assembly may comprise a dial lever connected with the air door by passing through the rotary sleeve. The dial lever has a degree of freedom to move in the second direction relative to the rotary sleeve. The wall surface of the rotary sleeve may be provided with an opening groove extending forward and backward; and the dial lever has a pin which may be movable in the opening groove. The dial lever assembly may comprise an up-down toggle sleeve rotatably mounted on the housing about a first direction; and one of the front and rear rows of blades may be connected with the up-down toggle sleeve; the dial lever may be rotatable about a second direction relative to the up-down toggle sleeve, the second direction may be perpendicular to the first direction; and the other one of the front and rear rows of blades may be connected to the dial lever. The dial lever passes through the up-down toggle sleeve and has a degree of freedom to rotate relative to the up-down toggle sleeve. One of the front and rear rows of blades has a first blade drive link and may be connected with the up-down toggle sleeves by a first blade drive gear; and the first blade drive link has a shaft with which one end of the first blade drive gear may be connected; and the up-down toggle sleeve has a first tooth; and the other end of the first blade drive gear may be engaged with the first tooth. The other one of the front and rear rows of blades has a second blade drive link and may be connected with the dial lever by a ball socket structure; the second blade drive link has a ball socket; and the dial lever has a ball head; alternatively, the second blade drive link has a ball head; and the dial lever has a ball socket; and the ball head may be received in the ball socket. The air outlet structure may comprise an air door, the dial lever assembly may comprise an air door dial lever inserted into the dial lever; and the air door may be controlled by rotating the air door dial lever. The air door dial lever has a degree of freedom to rotate relative to the dial lever. The air door dial lever may be connected with the air door by a worm/gear. One of the air door dial lever and the worm/gear may be provided with a ball socket, the other one may be provided with a ball head; and a convex point on the ball head may be matched with a groove on the ball socket, so that the air door dial lever drives the rotation of the worm/gear.

### Exemplary Embodiments—C

As indicated schematically, a vehicle may an air conditioning system for heating or cooling air and supplying the heated or cooled air to the interior space of the vehicle compartment through an air outlet structure. See FIGS. 1A-1D.

FIG. 16 shows a conventional outlet structure comprising a housing 1x, a horizontal blade assembly 2x, a perpendicular blade 3x and an air door 4x; the horizontal blade assembly 2x may be installed at the front end of the housing 1x by a panel 11x, the perpendicular blade 3x may be installed at the middle of the housing 1x by a support 12x; and the air door 4x may be installed at the rear end of the housing 1x. As indicated schematically, a toggle button 5x may be installed on one blade in the middle of the horizontal blade assembly 2x, the toggle button 5x can drive the rotation of horizontal blade assembly 2x by toggling upward and downward, the toggle button 5x can drive the rotation of the perpendicular blade 3x by toggling leftward and rightward; and the air door 4x is opened and closed by another structure. Since the perpendicular blade 3x is driven by the leftward and rightward toggling of the toggle button 5x, the results in a need for a large arrangement space, which is not applicable to a spatially limited environment. As indicated schematically, since the toggle button 5x is installed on one blade in the middle of the horizontal blade assembly 2x, the structure occupies a certain space and can shield the air blowing and influence the air blowing effect. As shown schematically in FIG. 16, since the air outlet is narrow, the air outlet structure may comprise a follow-up blade 6x installed on a hidden blade to optimize the air guiding effect. In order to arrange the follow-up blade 6x, the front end of the perpendicular blade 3x needs to be partially cut away, thus affecting the air guidance of the perpendicular blade 3x. In order to avoid cutting away a large part of the perpendicular blade 3x, it is usually necessary to move the perpendicular blade 3x back in the entirety, which requires an increase in the space of the housing and causes inapplicability for spatially limited environment.

As indicated schematically in FIGS. 1C-1D, 2A-2B and 17A-17B, an air outlet assembly for airflow in a vehicle interior may comprise a housing, a vertical guide assembly, a horizontal guide assembly and an operator control to actuate a vertical guide mechanism and a horizontal guide mechanism. The operator control may comprise a knob and a shaft providing an axis. Rotation of the operator control may comprise rotation of the shaft about the axis; pivoting of the operator control may comprise linear movement of the knob between a raised position and a lowered position. The operator control may translate to actuate an air door assembly to permit airflow and to obstruct airflow. Translation of the operator control may comprise linear movement of the shaft in a direction along the axis. The operator control may actuate the vertical guide mechanism independently of the horizontal guide mechanism.

As indicated schematically in FIGS. 1C-1D, 2A-2B and 17A-17B, a component for a vehicle interior may comprise an air outlet assembly for airflow comprising an air outlet structure comprising a dial lever assembly and front and rear rows of blades which are arranged on a housing; one of the front and rear rows of blades is controlled by shifting the dial lever assembly up and down; and the other one of the front and rear rows of blades is controlled by rotating the dial lever assembly; the opening and closing of front and rear rows of blades are independently controlled by different actions of the dial lever. As indicated schematically, the opening and closing of an air door can be independently controlled; the horizontal blades of the front row of blade assemblies rotate up and down by shifting a dial lever assembly up and down, the perpendicular blades of the rear row of blade assemblies rotate left and right by rotating the dial lever assembly; and the opening and closing of the air door are realized by retracting and extending the dial lever assembly, which not does not affect each other, but achieves a compact arrangement of the space.

TABLE A
REFERENCE SYMBOL LIST

| ELEMENT, PART OR COMPONENT | REFERENCE SYMBOL |
|---|---|
| vehicle | V |
| interior | I |
| instrument panel | IP |
| air outlet assembly/structure | AR |
| operator control (knob/dial and shaft/ | OC |
| member) | |
| base | B |
| housing | H |
| horizontal guide/blade assembly | HB |
| horizontal guide/blade mechanism | HM |
| vertical guide/blade assembly | VB |
| vertical guide/blade mechanism | VM |
| air door assembly | AD |
| air door mechanism | ADM |
| housing | 1 |
| horizontal blade assembly | 2 |
| perpendicular (vertical) blade assembly | 3 |
| air door assembly | 4 |
| dial lever assembly/operator control | 5 |
| dial lever/operator control | 53 |
| front half-housing | 11 |
| rear half-housing | 12 |
| partition wall | 13 |
| horizontal blade support | 21 |
| horizontal blades | 22, 23, 24 |
| left-side shaft | 27 |
| right-side shaft | 28 |
| link shaft | 29 |
| horizontal blade linkage link | 25 |
| horizontal blade drive link | 26 |
| hole | 261 |
| shaft | 262 |
| first slide groove | 131 |
| perpendicular blade drum | 31 |
| perpendicular blades | 32, 33, 34, 35, 36, 37 |
| left side wall | 121 |
| perpendicular blade linkage link | 38 |
| perpendicular blade drive link | 39 |
| ball socket | 391 |
| ball head | 321 |
| ball socket | 392 |
| first air door | 41 |
| second air door | 42 |
| air door tooth bar | 43 |
| first gear | 411 |
| second gear | 421 |
| upper tooth bar | 431 |
| lower tooth bar | 432 |
| air door drive link | 44 |
| a shaft rod | 442 |
| shaft hole | 433 |
| ball | 441 |
| up-down toggle sleeve | 51 |
| rotary sleeve | 52 |
| rotating shaft | 511 |
| pin | 512 |
| first tooth | 514 |
| second slide groove | 132 |
| sleeve | 513 |
| ball head | 521 |
| shaft | 532 |
| open groove | 522 |
| pin | 533 |
| ball socket | 531 |
| horizontal blade drive gear | 54 |
| mounting shaft | 133 |
| second tooth | 541 |
| receiving hole | 542 |
| vertical drum connecting gear | 55 |
| vertical drum conversion gear | 56 |
| mounting shaft | 134 |
| housing | 10 |
| horizontal blade assembly | 20 |
| perpendicular blade assembly | 30 |
| air door assembly | 40 |
| dial lever assembly | 50 |
| dial lever | 520 |
| air door dial lever | 530 |
| front half-housing | 110 |
| rear half-housing | 120 |
| partition wall | 130 |
| horizontal blade support | 210 |
| horizontal blades | 220, 230, 240 |
| left-side shaft | 270 |
| right-side shaft | 280 |
| link shaft | 290 |
| horizontal blade linkage link | 250 |
| horizontal blade drive link | 260 |
| Hole | 2610 |
| Shaft | 2620 |
| first slide groove | 1310 |
| perpendicular blade drum | 310 |
| perpendicular blades | 320, 330, 340, 350, 360, 370 |
| left side wall | 1210 |
| perpendicular blade linkage link | 380 |
| perpendicular blade drive link | 390 |
| ball socket | 3910 |
| ball head | 3210 |
| first air door | 410 |
| second air door | 420 |
| air door tooth bar | 430 |
| first gear | 4110 |
| second gear | 4210 |
| upper gear tooth bar | 4310 |
| lower gear tooth bar | 4320 |
| air door worm/gear | 440 |
| up-down toggle sleeve | 510 |
| dial lever | 520 |
| rotating shaft | 5110 |
| Pin | 5120 |
| first tooth | 5140 |
| Sleeve | 5130 |
| ball head | 5210 |
| ball socket | 3920 |
| ball head | 5310 |
| protrusion | 5310a |
| ball socket | 4410 |
| groove | 4420 |
| protrusion | 5310a |
| horizontal blade drive gear | 540 |
| mounting shaft | 1330 |
| second tooth | 5410 |
| receiving hole | 5420 |
| vertical drum connecting gear | 550 |
| vertical drum conversion gear | 560 |
| mounting shaft | 1340 |
| housing | 1x |
| horizontal blade assembly | 2x |
| perpendicular blade | 3x |
| air door | 4x |
| panel | 11x |
| support | 12x |
| toggle button | 5x |
| follow-up blade | 6x |

It is important to note that the present inventions (e.g. inventive concepts, etc.) have been described in the specification and/or illustrated in the FIGURES of the present patent document according to exemplary embodiments; the embodiments of the present inventions are presented by way of example and are not intended as a limitation on the scope of the present inventions. The construction and/or arrangement of the elements of the inventive concepts embodied in the present inventions as described in the specification and/or illustrated in the FIGURES is illustrative. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. An air outlet assembly for airflow in a vehicle interior comprising:
(a) a housing providing an outlet;
(b) a vertical guide assembly configured to guide airflow through the outlet;
(c) a horizontal guide assembly configured to guide airflow through the outlet;
(d) an operator control configured to actuate (1) a vertical guide mechanism for the vertical guide assembly and (2) a horizontal guide mechanism for the horizontal guide assembly;
wherein the operator control is configured to provide a rotating action and a pivoting action.

2. The air outlet assembly of claim 1 wherein the operator control is configured to actuate an air door assembly; wherein the air door assembly is configured to be actuated by an air door mechanism.

3. The air outlet assembly of claim 2 wherein the operator control is configured to provide a translating action to actuate the air door assembly between an open position to permit airflow and a closed position to obstruct airflow.

4. The air outlet assembly of claim 3 wherein translating action of the operator control comprises linear movement of the shaft in a direction along the axis between a retracted position and an extended position.

5. The air outlet assembly of claim 2 wherein the air door assembly comprises a set of air doors; wherein the operator control is configured to pivot the set of air doors for the air door assembly between the open position and the closed position.

6. The air outlet assembly of claim 2 wherein the air door assembly comprises a set of air doors; wherein the set of air doors comprises a set of panels.

7. The air outlet assembly of claim 2 wherein the operator control is configured to actuate the air door mechanism independently of the vertical guide mechanism and/or the horizontal guide mechanism.

8. The air outlet assembly of claim 2 wherein the air door mechanism comprises a gear arrangement configured to operate the air door assembly.

9. The air outlet assembly of claim 1 wherein the operator control comprises a knob and a shaft providing an axis; wherein the knob comprises a dial and the shaft comprises a tube.

10. The air outlet assembly of claim 1 wherein the operator control comprises a knob on a shaft projecting from an opening in the housing.

11. The air outlet assembly of claim 10 wherein the opening comprises a slot in the housing.

12. The air outlet assembly of claim 1 wherein the rotating action of the operator control comprises rotation of the shaft about the axis; wherein the pivoting action of the operator control comprises linear movement of the knob between a raised position and a lowered position.

13. The air outlet assembly of claim 1 wherein the vertical guide assembly comprises a set of vertical guides; wherein the vertical guide mechanism is configured to move the set of vertical guides in a horizontal direction.

14. The air outlet assembly of claim 1 wherein the horizontal guide assembly comprises a set of horizontal guides; wherein the horizontal guide mechanism is configured to pivot the set of horizontal guides in a vertical direction between a raised position and a lowered position.

15. The air outlet assembly of claim 1 wherein the operator control is configured to actuate the vertical guide mechanism independently of the horizontal guide mechanism.

16. The air outlet assembly of claim 1 wherein the vertical guide mechanism comprises a link member configured to operate the vertical guide assembly.

17. The air outlet assembly of claim 1 wherein the horizontal guide mechanism comprises a gear arrangement configured to operate the horizontal guide assembly; wherein the gear arrangement comprises a gear set.

18. The air outlet assembly of claim 1 further comprising a base for the housing; wherein the base comprises an inlet for airflow.

19. The air outlet assembly of claim 1 wherein at least one of (a) the vertical guide assembly is mounted within the base; (b) the horizontal guide assembly is mounted within the base; (c) the air door assembly is mounted within the base.

20. An air outlet assembly for airflow in a vehicle interior comprising:
(a) a base providing an inlet;
(b) a housing providing an outlet;
(c) a vertical guide assembly within the base configured to guide airflow through the outlet;
(d) a horizontal guide assembly within the base configured to guide airflow through the outlet;
(e) an operator control configured to actuate (1) a vertical guide mechanism for the vertical guide assembly and (2) a horizontal guide mechanism for the horizontal guide assembly;
wherein the operator control is configured to provide a rotating action and a pivoting action;
wherein the operator control is configured to actuate the vertical guide mechanism independently of the horizontal guide mechanism.
